(19) United States
(12) Patent Application Publication
(10) Pub. No.: US 2014/0047315 A1
(43) Pub. Date: Feb. 13, 2014

(54) METHOD FOR IDENTIFYING POTENTIAL DEFECTS IN A BLOCK OF TEXT USING SOCIALLY CONTRIBUTED PATTERN/MESSAGE RULES

(71) Applicant: Ross Neil Williams, Adelaide (AU)

(72) Inventor: Ross Neil Williams, Adelaide (AU)

(73) Assignee: CITADEL CORPORATION PTY LTD, Adelaide (AU)

(21) Appl. No.: 14/112,158

(22) PCT Filed: Apr. 18, 2012
(86) PCT No.: PCT/AU2012/000393

§ 371 Date: Oct. 16, 2013

(30) Foreign Application Priority Data
Apr. 18, 2011 (AU) 2011901449

(51) Int. Cl. G06F 17/24

(52) U.S. Cl. CPC G06F 17/241
USPC 715/230

(57) ABSTRACT

This invention provides a method and apparatus for identifying potential errors in a block of text using rules contributed by a plurality of users. Each rule consists of a pattern (which matches parts of a block of text) and a message (which provides helpful information). A group of rules is applied to a block of text to generate a report that binds messages with sites in the text where the corresponding rule patterns matched. Users can create, organise, edit, publish, rate, and combine rules and groups of rules. User ratings are used to generate better reports. The invention has many potential embodiments, with a web interface being an exemplary embodiment.

### FIELD

The present invention provides a method and apparatus for annotating a block of text using a collection of socially-contributed pattern/message rules, and for organising collections of rules.

### INCORPORATED DOCUMENTS

This application claims the benefit of Australian Provisional patent specification 2011901449 filed by me and is entitled “METHOD FOR IDENTIFYING POTENTIAL DEFECTS IN A BLOCK OF TEXT USING SOCIALLY CONTRIBUTED PATTERN/MESSAGE RULES” which is dated and was filed on Apr. 18, 2011, thus being a related patent application and is hereby incorporated in full by reference into this specification, but is not admitted as forming any part of the prior art.

### BACKGROUND

Documents of all kinds frequently contain errors, and frequently contain errors that are repeated over and over in different documents written by different authors. A number of tools exist for analysing documents for errors, including the following categories:
Spell Checkers: Spell checkers look for words that are not present in a comprehensive dictionary of words. If a word is not present, it is flagged as a potential error. An example is the spell checker in the Microsoft Word document editing software.
Grammar Checkers: Grammar checkers perform sophisticated parsing of a document and identify potential grammatical errors. An example is the grammar checker in the Microsoft Word document editing software.
Readability Checkers: There are some analysis tools that analyse the length of words and sentences to calculate a metric of readability. An example is the Flesch-Kincaid Grade Level test.

These tools provide a formal check for particular classes of error in a document. However, they provide checks only for very specific classes of errors. There are many other classes of error for which no tools exist. Even if they did exist, applying several tools to a document separately would be prohibitively time consuming Also, historically, these tools have typically been created and published by a single entity (e.g. a software company) and do not harness the huge potential for the creation of socially-contributed content that has been seen in, for example, the Wikipedia online encyclopaedia website (www.wikipedia.org).

The potential exists to create a single integrated tool that can identify many classes of error, and whose capabilities are continually improving as a result of contributions made by its own users.

### SUMMARY

The present invention is based on a few key observations:
1. Many of the errors that appear in documents can be detected using very simple text patterns. Many errors can be detected simply by matching word sequences. For example, the words “mute point” almost always indicate an error (the author meant “moot point”). Each word on its own might be correct, but the two together indicate an error.
2. It is often useful to detect a potential error (as well as errors), if the chance of the potential error being an error is high enough. For example, in contemporary texts, the use of the word “loose” very often means that the author really intended to use the word “lose”. This kind of error occurs very frequently, but will not be detected by, for example, a spell checker which will recognise the word “loose” as a correctly-spelt word, which it is.
3. If thousands of pieces of knowledge about errors and potential errors in documents are accumulated in one tool, the tool will be very powerful and useful. This kind of mass accumulation of small pieces of knowledge can be achieved if large numbers of users contribute small pieces of knowledge as, for example, they have done to create Wikipedia.

In an aspect of the invention, an information system (e.g. a website) is created to store and organise large numbers of pattern/message rules contributed by a plurality of users. An example of a pattern/message rule is a rule with a pattern of “incourage” and a message of “Did you mean ‘encourage’ ?”. These rules can be applied to a document to generate useful annotations. For example, if this rule were applied to a document that contained the word “incourage”, the message “Did you mean ‘encourage’?” would be associated with that part of the document for display to the user.

In an aspect of the invention, users of the system can contribute rules, organise rules into groups of rules called rulesets, include rulesets in other rulesets, and apply rulesets to documents to yield detailed annotations of the documents.

With millions of rules in the system, documents are likely to be annotated too densely for human consumption. In an aspect of the invention, users can rate rules and rulesets, and higher-rating rules and rulesets are given priority over lower-rating rules and rulesets. In an aspect of the invention, the user specifies the maximum number of annotations the user wants to see (say N annotations), and the system chooses the top N matching annotations for display. If the user wants more annotations, the next highest-rating annotations can be displayed.

In an aspect of the invention, a website creates an environment where users can create rules, organise rules into rulesets, create rulesets that include other rulesets, rate rules and rulesets and users, and apply rulesets to documents to analyse them. From all this will emerge a facility that will provide truly useful annotations of documents.

### TERMINOLOGY

Annotation—The association of a rule instance to a block of text.

Block of Text—A sequence of zero or more characters.

Condensation—A data structure created from a ruleset that can match the rules in the ruleset against a block of text at high speed (typically in a single pass of the text).

Condense—The process of creating a condensation from a ruleset.

Descendant—A rule or ruleset X is a descendant of a ruleset Y if X's parent, or X's parent's parent, or further is Y.

Document—A block of text that possibly also carries associated metadata such as font and style information.

Entity—A legal person, being a person or a corporation or similar

Fire—A rule fires when its pattern matches some part of a block of text and its message is incorporated into the report.

Firing—A particular instance of the incorporation of a particular rule's message into a report.

Inclusion List—An ordered list of commands that define rules and rulesets to be included in a ruleset.

Information Presentation Arrangement—A means of presenting information (often a report) to a user. Examples of information presentation arrangements are: a web page, an email message, a mobile phone text message, a sound, an image, a video, and a PDF document.

Rating—A numerical rating of a User, Rule, or Ruleset accumulated over time from the performance of the User, Rule, or Ruleset. The term is also used to describe a particular rating of a particular object by a particular user.

Match—A rule matches part of a text block if its pattern matches that part of the text block. A rule can match without firing.

Matching Status—The matching status of a pattern is a Boolean value that is true if the pattern matches and false if the pattern doesn't match.

Message—A body of information associated with a rule. A rule's message can take various forms (e.g. text, audio, video), and these can be incorporated into a report when a block of text is analysed.

Mixin—A rule or ruleset that is included in a ruleset without being a descendant of the ruleset. Mixins allow a ruleset to include arbitrary rulesets and rules.

Object—A data record that represents a rule, ruleset, user, user group, or other similar thing.

Part of a Block of Text—A contiguous sequence of zero or more characters within a block of text.

Pattern—A formal constraint on text that can be tested at any point in a block of text to determine whether the pattern matches at that point. An exception is some kinds of pattern that will either match or not match an entire block of text rather than match at a particular position within a block of text.

Priority—A number assigned to a rule or ruleset by a ruleset. A higher priority indicates greater importance. Priorities can be used to rank annotations.

Protection—A specification of the set of users that are permitted to perform a class of operation on an object or class of object. A protection will often refer to a user group to define the set of users that are allowed to perform the operation.

Regular Expression—An expression that specifies a set of strings, typically in a form that is more concise than an enumeration of the set. A regular expression can be used as a pattern, and matches if the string being matched is a member (or, in some matching contexts, contains a member) of the regular expression's set of strings. In this document, the term has the same meaning as it does in the field of Computer Science and this meaning is found in Wikipedia at http://en.wikipedia.org/wild/Regular_expression

Report—A collection of annotations of a block of text. A report is usually created for presentation to a user. Reports can exist in a wide variety of forms.

Rule—A rule comprises a pattern and a message.

Rule Instance—A rule instance is bound to a position in a block of text to form an annotation.

Rule Number—A unique number assigned to each rule.

Ruleset—A collection of one or more rules. Rulesets are sets because each ruleset defines a subset of the set of all rules in the universe of rules.

Text—Another name for a block of text.

Universe of Rules—The set of all rules in the system.

User—The person who is using an embodiment of the invention.

User Group—A set of zero or more users. User groups can be named, and can be referred to in protections.

### BRIEF DESCRIPTION OF FIGURES

FIG. 1 provides an example of an aspect of the invention embodied as a website. This figure shows just one page of the website, and is an actual screen snapshot of a password-protected website prototype embodiment of aspects of the invention. The page presents a web form consisting of a text input field into which the user can paste a block of text to be analysed. There is also a dropdown menu which allows the user to select the format of the analysis report. When the user clicks on the form's submit button “Analyse”, the website displays the analysis report. In this prototype, the text box comes with a default text that the user can read or choose to analyse. The example text contains several errors, so that if the user decides to analyse the default text, the user will see how these errors are identified in the output. The prototype shown here contains hundreds of rules, but has just one user (the inventor). For the purposes of exposition, we can imagine that the rules have been contributed by more than one user.

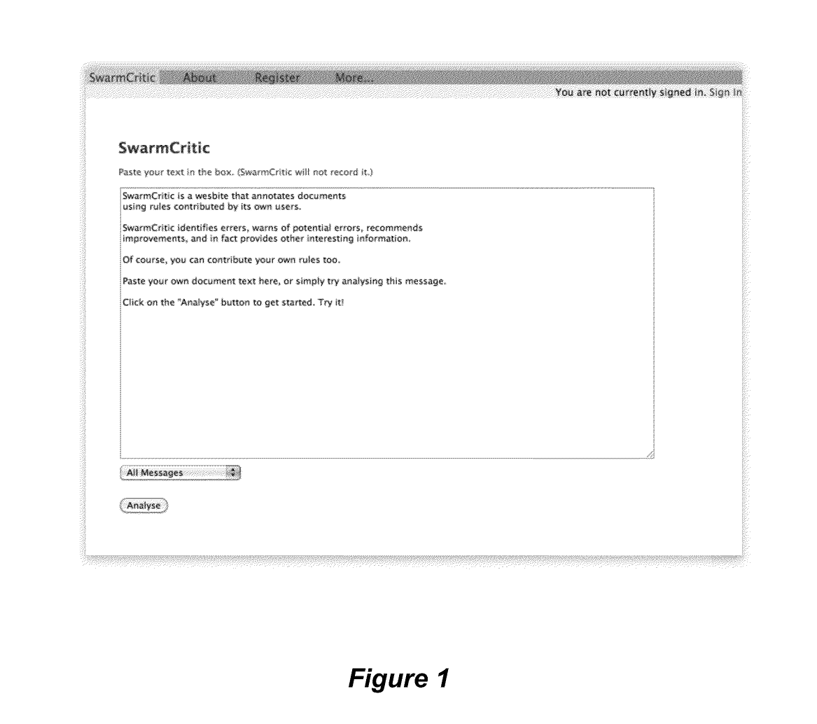

FIG. 2 provides an example of an aspect of the invention embodied as a website. This figure shows just one page of the website, and is an actual screen snapshot of a password-protected website prototype embodiment of aspects of the invention. The page shown is the results yielded by submitting the web form shown in FIG. 1. In this example, exactly five rules have fired once each, yielding five different annotations that identify two errors, one warning, and two recommendations. In this embodiment, the original text is in black. The parts of this text that matches rule patterns are highlighted in pink and the corresponding rule messages are displayed in red. In this particular embodiment, clicking on a red message displays the associated rule's web page containing more information. In this particular embodiment, the firings are numbered sequentially, with each number preceded by its severity (E for an Error, W for a Warning, and R for a Recommendation). The string “bgejptdt.home” is the name of the ruleset being used and consists of the user's username “bgejptdt” followed by the name of the ruleset (“home”).

FIG. 3 provides a flow chart for an aspect of the invention depicting the step of applying rules to a block of text and the step of associating the messages of matching rules with the block of text. In an embodiment the method for annotating a block of text is using a plurality of rules created by a plurality of entities. The plurality of rules comprising a text pattern and a message and the method comprises the steps of (a) matching the text patterns of a plurality of rules to the block of text, depicted as applying the rules to the block of text; and (b) associating with the block of text the message of at least one rule having a matching pattern. The message or messages annotating the block of text is not illustrated.

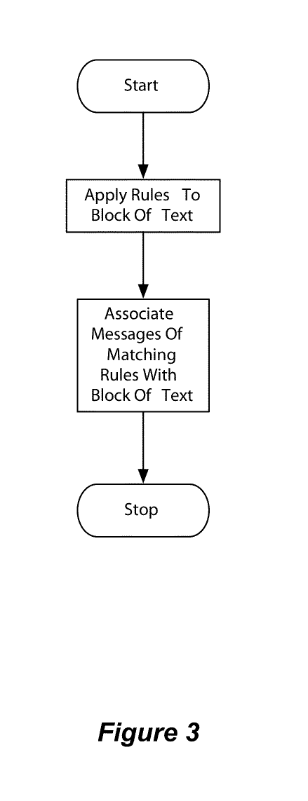

FIG. 4 shows a typical physical embodiment of an aspect of the invention, including a server computer that serves information to a number of client (remote user) computers on the internet. In a typical embodiment, the server would hold the rules and would perform the matching. The client would send a block of text and receive back an annotated block of text. In other embodiments, the clients receive rules from the server and apply them to a block of text themselves.

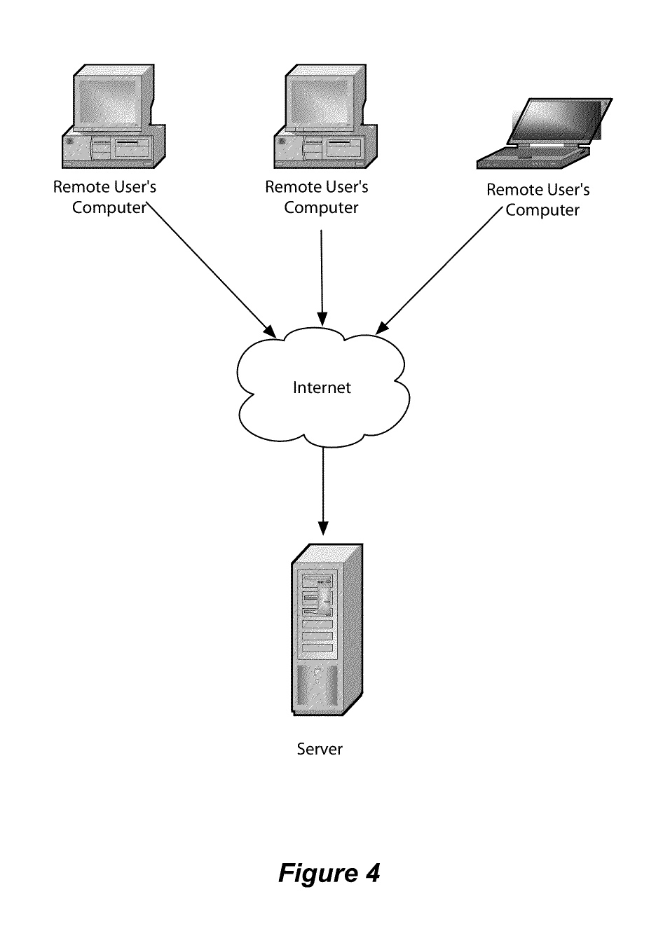

FIG. 5 shows FIG. 1 presented on a client computer, here a laptop computer.

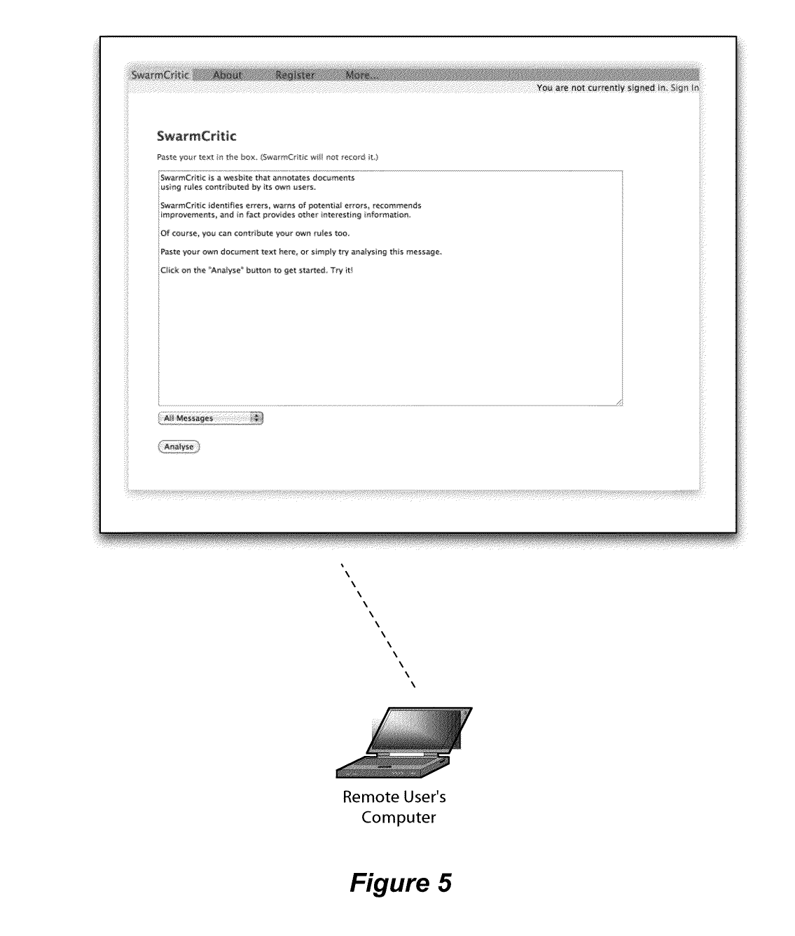

FIG. 6 shows FIG. 2 presented on a client computer, here a laptop computer.

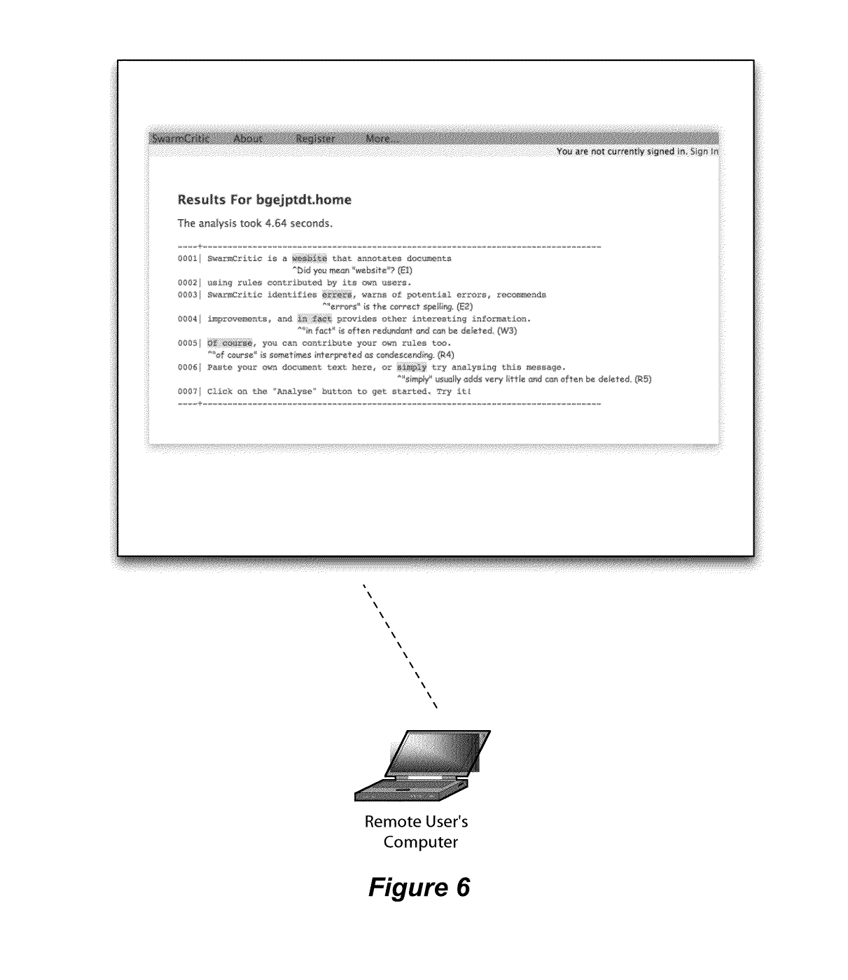

FIG. 7 provides a schematic diagram of a computer server in which aspects of this invention could be embodied. The embodiment can be in the form of a system for annotating a block of text comprising, a processor; and a memory for storing a plurality of rules created by a plurality of entities, a plurality of rules comprising a text pattern and a message and storing the block of text; the processor being programmed to receive the block of text and for matching the text patterns of a plurality of rules to the stored block of text; and associating with the block of text the message of at least one rule having a matching pattern, the message or messages annotating the block of text. It will be well known to those skilled in the art how to create computer software code to create rules, to store those rules in RAM or other memory, including Hard Drive memory, to receive and store a block of text and to perform matches of text patterns to a block of text, create an association between a message or messages to the block of text and then annotate the block of text. The software code can reside on one computer or cooperating parts of the software can reside on two or more computers for receiving and sending data via appropriate input and output ports between the memories of respective computers and having one or more processors operate the computer software code to do one or more of these tasks.

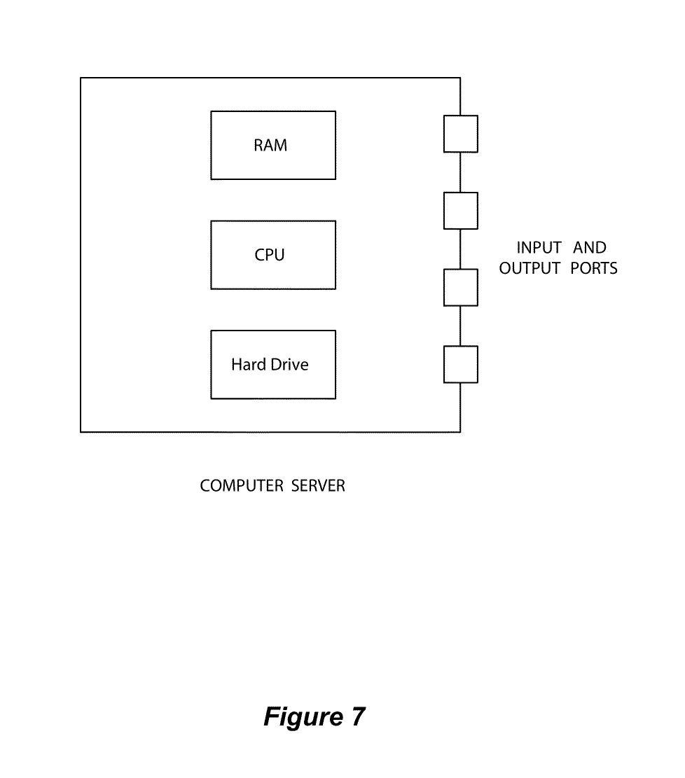

In another embodiment there is a computer program product using a computer usable medium such as a data carrier or data storage element having computer readable programme code embodied therein, and the code adapted to be executed to implement any of the methods described within the specification.

FIG. 8 shows how a remote user can analyse a block of text by transmitting it to a server for analysis, and receiving the resultant output.

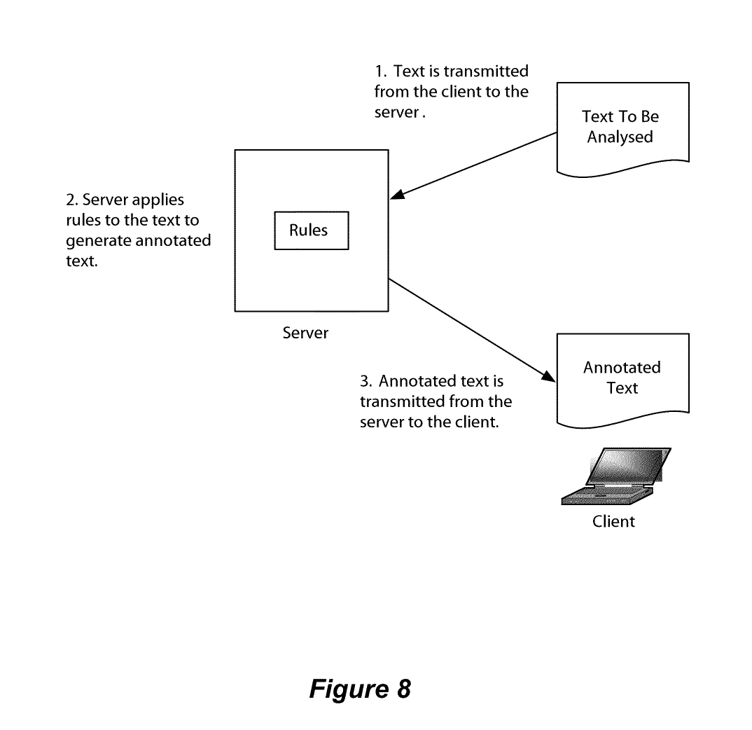

FIG. 9 shows a short list of pattern/message rules. When a pattern is detected in a block of text, the corresponding message is associated with the block of text and in one embodiment the message or messages can be displayed to assist the user so as to annotate the block of text.

FIG. 10 shows an analysis where the rules of FIG. 9 have been applied to a block of text, yielding a report of annotations to assist the user. Each annotation is bound to a particular place in the text where a rule's pattern matched the text (here shown in bold). There are many ways in which a report could be presented to a user.

FIG. 11 shows the rules of FIG. 9 represented as a word tree. Each node in the tree represents a string, with the root node being the empty string (to avoid clutter, these strings are not shown). Each arc on the tree is labelled with a word that is appended (with a space) to its parent node's string to yield its child node's string. On nodes corresponding to rule patterns, one or more rule messages are attached (possibly along with a link to each rule's record (not shown here)). Word trees allow a block of text consisting of words to be matched quickly against a collection of rules (in embodiments where patterns are lists of words) by traversing the word tree (starting from the root) at each position in the block of text (not shown here).

FIG. 12 shows how a word tree can be constructed for a plurality of rulesets. Here we see three rulesets, each of which contains five rules. A word tree has been constructed for each ruleset. In this figure, each word tree is represented by a triangle. Each word tree is similar, in form, to the word tree depicted in FIG. 11. By constructing a word tree for each ruleset proactively, the server is always ready to analyse a block of text with any ruleset.

FIG. 13 shows three rulesets called X, Y, and Z that have some inclusion relationships. The R letters represent rules. The small black circles represent inclusions. Ruleset Y includes ruleset Z. Ruleset X includes ruleset Y. This means that Z contains just its own four rules, whereas Y contains nine rules being its own rules and Z's rules. Ruleset X contains 14 rules being its own rules and also the rules of Y (which includes the rules of Z).

FIG. 14 shows a collection of rulesets (containing rules shown as R) whose inclusion relationships form a directed graph structure. An arrow indicates that a ruleset includes the contents of the pointed-to ruleset. Inclusions are transitive, so if a ruleset X includes a ruleset Y, X includes the rules directly in Y and the result of Y's inclusions too. In practice, it makes most sense for these graphs to be directed acyclic graphs, but directed cyclic graphs could be accommodated so long as cycles are sensibly handled by the software.

FIG. 15 shows an exemplary embodiment architecture for a scalable embodiment. All the rules and rulesets, and user information and other data are stored in a database in a database server pool. The database could take the form of a single database (with database servers attached to it to handle requests), or a distributed replicated database system. A user process (e.g. web browser process) connects through a network to a pool of interface servers, one of which is assigned to the user process. The user process makes a request (e.g. “update this rule” or “analyse this block of text”) and the interface server determines how to process the request. If the request involves a simple update such as modifying a rule, the interface server communicates with one of the database servers and makes the change. However, if the request is to analyse a block of text, the interface server passes the request onto one of the matching servers (in the matching server pool), which processes the request and returns an analysis to the interface server. Each matching server stores a condensed representation of one or more rulesets in its memory. These are ready to be applied at high speed to any incoming blocks of text. Matching servers construct the condensations by accessing the rulesets and rules in the database from time to time and constructing the condensations from them. In this figure many lines have an arrowhead on one end. These lines indicate that the entity on the non-arrowhead end has made a network connection to a server on the arrowhead end. The arrowheads do not imply that data flows only in the direction of the arrow once the connection is established.

FIG. 16 shows a federated server architecture that enables each of a plurality of organisations to create rulesets, share rulesets with other organisations and users, copy rulesets from other servers, and analyse confidential documents using externally-created rulesets on the organisation's server. The bottom of the diagram shows a single organisation which has an intranet. The organisation has an organisational server for managing rules and rulesets. The server is implemented using one or more physical or virtual processors. An organisational server might “lurk” on the network, only ever copying rulesets from other servers, or it might publish its own rulesets, or accept and analyse documents from external users. A very common mode of operation will be that an organisational server lurks by only reading rulesets from the outside network, but allows users on its intranet to create rules and rulesets and publish them for use within the organisation, and allows users within the organisation to perform analyses on blocks of text.

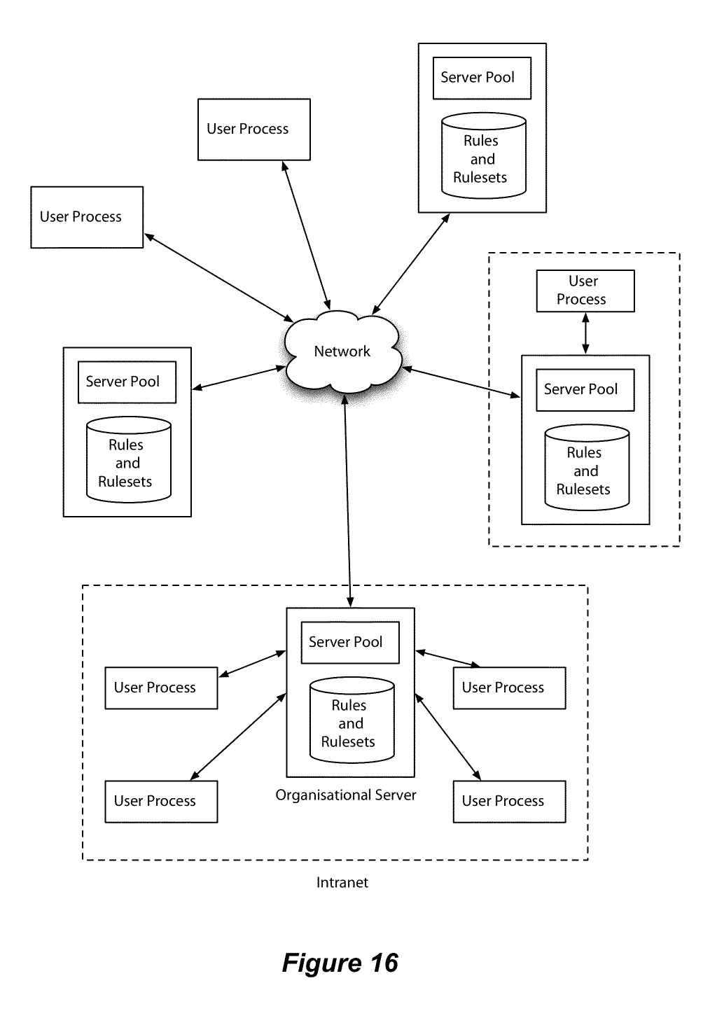

FIG. 17 shows a collection of rulesets each of which contains some rules. Each rule is represented by a letter. Many of the rulesets include other rulesets, and these inclusion relationships are represented by the black dots and lines with arrows. For example, ruleset 1 includes ruleset 2 and ruleset 3. The contents of each ruleset is defined by the transitive closure of the inclusion relationships. Thus ruleset 1 contains not just rules ABC or ABCDEFGH, but ABCDEFGHIJKLMNOPQRS.

FIG. 18 shows a flow chart for an aspect of the invention depicting matching, associating, and annotating steps.

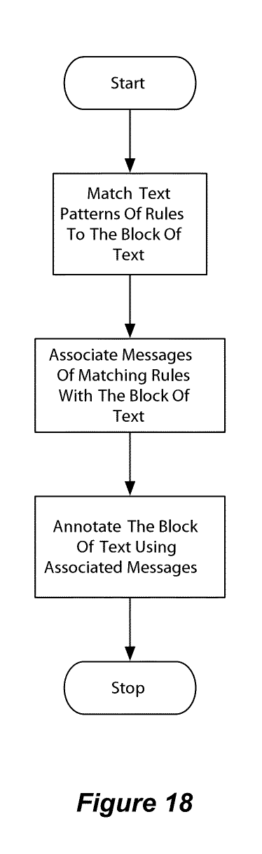

FIG. 19 shows an example of how a pattern matching operation can be performed. The text pattern “GREATEFUL” is to be matched to block of text “AM VERY GREATFUL FOR THE”. In this example, this matching operation is performed by comparing the first character of the pattern (“G”) with each character of the block of text. When a match is found, the second character of the pattern (“R”) is compared with the character after the “G”. This continues and if the end of the pattern is reached in this way, a match of the pattern has been found. If a comparison fails, we return to looking for the first character of the pattern (“G”) again. In this example, sixteen comparisons are performed before the first match is confirmed. The numbers 1 and 16 in this figure indicate the first and sixteenth comparison made.

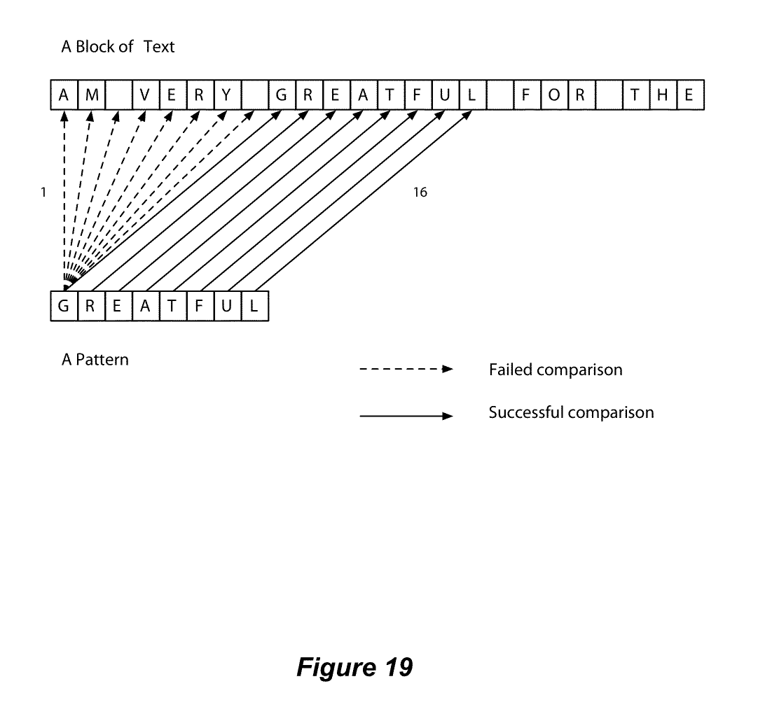

FIG. 20 shows an example of how a message can be associated with a block of text to form an annotation. In this example, the pattern “greatful” of a rule has matched and the rule's message has been associated with the block of text at the point of match to form an annotation.

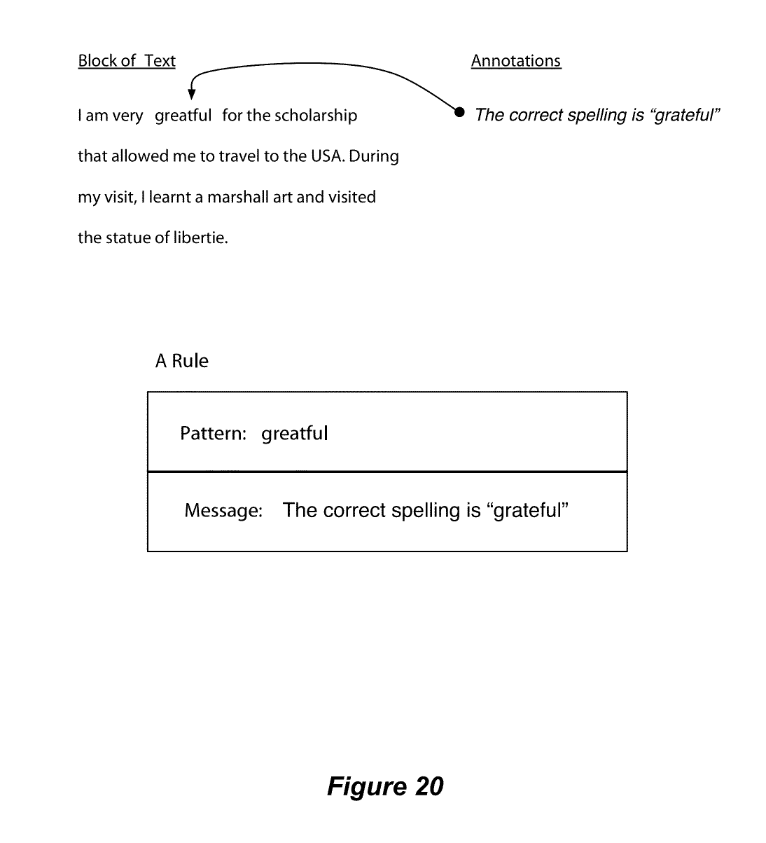

FIG. 21 shows an example of how a rule can be associated with a block of text to form an annotation. In this example, the pattern “greatful” of a rule has matched and the rule itself has been associated with the block of text at the point of match to form an annotation. This annotation can be used to create a report containing the rule's message.

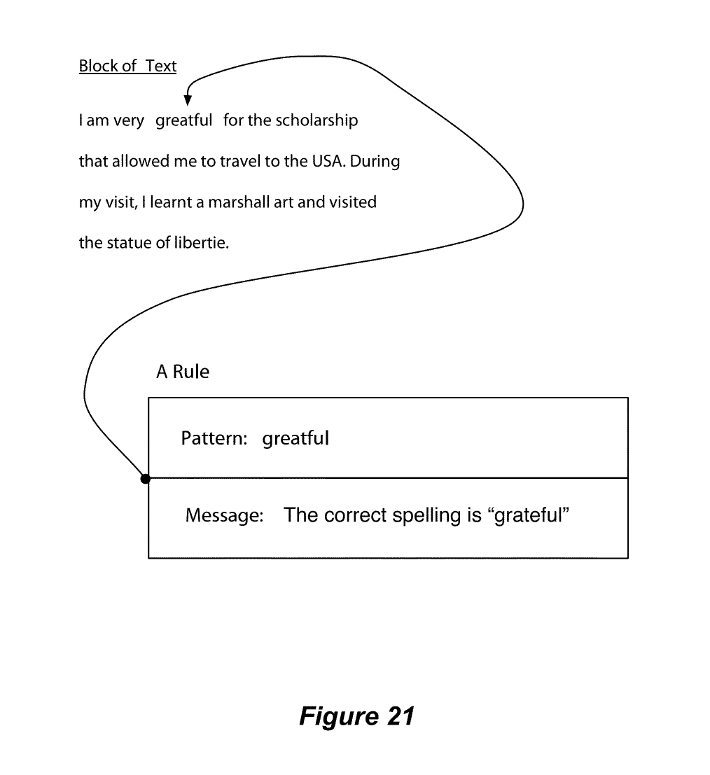

### DETAILED DESCRIPTION

Specific Embodiments are Illustrative

Specific embodiments of the invention will now be described in some further detail with reference to, and as illustrated in, the accompanying figures. These embodiments are illustrative, and are not meant to be restrictive of the scope of the invention. Suggestions and descriptions of other embodiments might be included within the scope of the invention, but they might not be illustrated in the accompanying figures or alternatively features of the invention might be shown in the figures, but not described in the specification.

Platforms

Aspects of the invention could be deployed on a variety of different computer platforms. In each case, the user/rule/ruleset data could be stored in a central server, with its possible distribution to remote client computers, or the client/server combination could be replaced by a single computer that holds all the user/rule/ruleset data, and analyses blocks of text directly.

In an aspect of the invention, the function of calculating a set of annotations of a block of text is distinguished (and possibly performed separately) from the function of presenting the annotations to the user. In a related aspect of the invention, a computer server (“server”) stores the information about users, rules, and rulesets, and the user, using a client computer (“client”), sends the block of text to be analysed to the server (or provides a reference to the block of text). The server analyses the block of text and generates a collection of annotations. It delivers this collection of annotations to the client, possibly sorting them by some metric first, possibly transmitting only the top N rules by that metric, and possibly delivering only some information about the rules (e.g. identifying rule numbers so that the client must later fetch more information about the annotations' rules) as required by the user. The client could then present the annotations to the user in a variety of forms, with or without further communication with the server. For example, if the server delivered the top 100 annotations, the client could present only the top five annotations, revealing the others only on request from the user and without recourse to the server.

Without limitation, the aspects of the generation of annotations and the display of annotations could be distributed between different computer systems. Here, without limitation, are some of the architectures that could be used.

In an aspect of the invention, the invention is embodied in a computer server that serves a website.

In an aspect of the invention, the invention is embodied in a computer server and a smart phone.

In an aspect of the invention, the invention is embodied in a computer server and a tablet computer.

In an aspect of the invention, the invention is embodied in a computer server and presented using an email interface. Users send a block of text by email to the server and the server emails back the annotations.

In an aspect of the invention, the invention is embodied in a computer server that presents a programmer's network interface, allowing programmers to create interfaces on new platforms.

Pooled Server Architecture

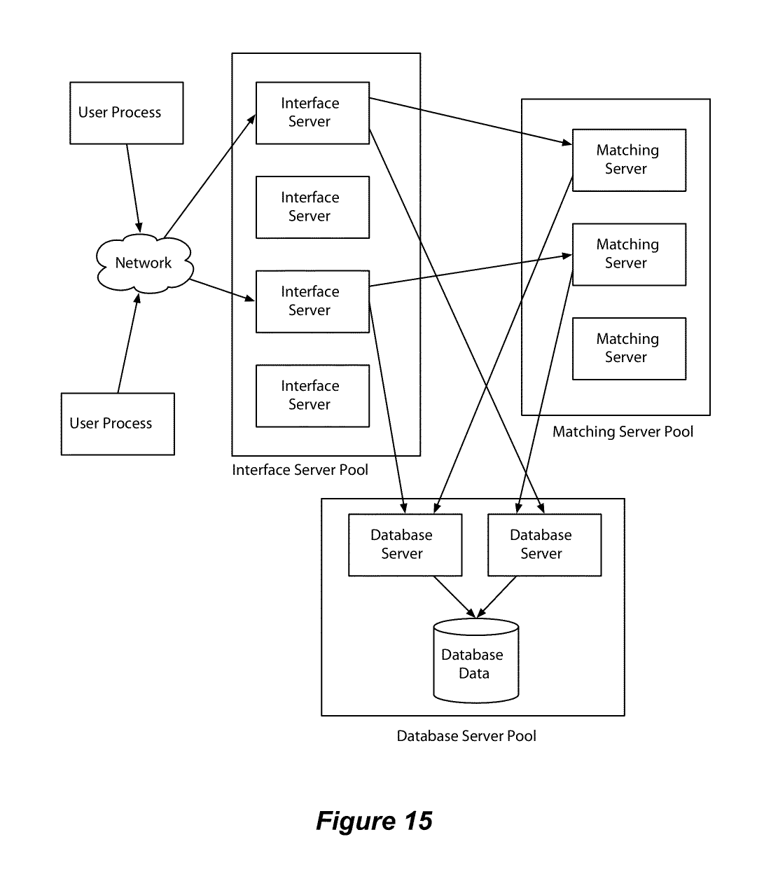

In an exemplary embodiment, the invention is embodied as three server pools, each of which contains a different kind of server (FIG. 15). A server could mean a physical computer, a virtual computer, or a process on a physical or virtual computer. The number of servers in each pool can be varied depending on the nature and volume of the traffic that arrives from user processes.

The interface server pool contains interface servers that accept connections from user processes. The connections will take the form of requests from user processes. The interface servers determine how best to process each request, and manage the execution of the request, possibly communicating with servers in the matching server pool and/or the database pool. If the embodiment is a website, then the interface servers will serve web requests (e.g. http requests).

The database server pool contains database servers that accept connections to access the database. All the rulesets, rules, and all other data is stored in a single database (which might be distributed or replicated) that presents itself using a pool of database servers to which connections can be made. Typically, the database will store all of its data on disk, caching some of it in memory.

The matching server pool contains matching servers whose primary purpose is to apply rulesets to blocks of text. Each matching server contains (at least) condensations of one or more rulesets. It uses these condensations to apply the rulesets to blocks of text presented to it by the interface servers. In an exemplary embodiment, the matching servers hold their condensations in memory so that they can be applied at high speed, and never store them on disk. Matching servers will frequently access the database and update their condensations to ensure that they match the latest changes that have been applied to the database by the interface servers. When a new matching server is created, it must access the database server to obtain a copy of the rulesets that it is serving (and to form condensations of them in memory) before it can accept requests. If all database records are written with an indexed modification date, matching servers can search for new records in the database efficiently.

Rules and rulesets can be distributed across the pool of matching servers in a variety of ways. At one extreme (an exemplary embodiment), each matching server contains all the rules and rulesetsm and incoming analysis requests are performed by a single matching server. At the other extreme, rules and rulesets are divided between the servers so that each rule or ruleset resides on just one matching server. In this embodiment, the block of text to be analysed is sent to all the matching servers, and the results combined (e.g. by the controlling interface server).

The exemplary embodiment handles requests as follows. A user process (e.g. a web browser) connects through a network to a pool of interface servers, one of which is assigned to the user process. The user process makes a request (e.g. “update this rule” or “analyse this block of text”) and the interface server determines how to process the request. If the request involves a simple update such as modifying a rule, the interface server connects to, and talks to, one of the database servers and makes the change. However, if the request is to analyse a block of text, the interface server passes the request (including the block of text and the name of the ruleset to be applied to it) onto one of the matching servers (in the matching server pool), which processes the request and returns an analysis to the interface server. The interface server then sends the analysis to the user process. The analysis returned might consist of just a list of positions in the text and corresponding rule identities, with the interface server presenting this information in a user-friendly form.

The exemplary pooled server architecture has a number of advantages over a single-server architecture. First, the number of servers in each pool can be scaled so as to handle large quantities of traffic. Second, the interface servers (in conjunction with the database servers) can handle most simple requests in a conventional manner without requiring a matching server. For example, if the user wants to modify a rule, the interface server that handles the request can just access a database server and make the change. The matching servers will notice the change and update themselves automatically. Third, the matching servers can focus exclusively on representing rulesets efficiently and applying them to blocks of text as quickly as possible. Matching servers can be hosted on computers with particularly large RAM memories so as to allow as many ruleset condensations to be stored in memory as possible. Fourth, because all the data officially resides in the database, the interface servers and matching servers do not need to manage any permanent storage. If an interface server or matching server crashes, it is a simple matter to create a new one.

Federated Server Architecture

The pooled server architecture provides an exemplary embodiment in the case where there is to be a single place of storage of all the data (e g a single database server pool). However, in practice, the need will arise for there to be more than one point of storage. For example, an organisation might want to create and serve one thousand of its own confidential rules to its staff and its customers only, while still using the tens of thousands of public rules published by other users. The organisation doesn't want to upload its confidential rules to a public server, but still wants to make use of the public server's rules.

This problem can be solved by using a federated server architecture. In this architecture, each organisation has its own server (or server pools). Each organisation places onto its server the rules and rulesets that it wishes to keep private and the rules and rulesets that it wishes to share with other specific organisations, or with the general public. An organisation's server will analyse documents presented to it by authorised users. Servers can talk to each other and exchange rules and rulesets. For example, if one organisation publishes a set of rules, another organisation might instruct its server to copy the set of rules so that its staff can perform analyses of confidential documents using those rules without having to send the confidential documents outside the organisation's intranet.

If a server X has too many rules to allow them to be easily copied, a server Y could send blocks of text for analysis by X instead of attempting to copy X's rules. Y could blend the analysis provided by X with Y's own analysis. In general, a server could send a block of text to a plurality of other servers and receive analysis results from all of them and merge the results.

General Operation

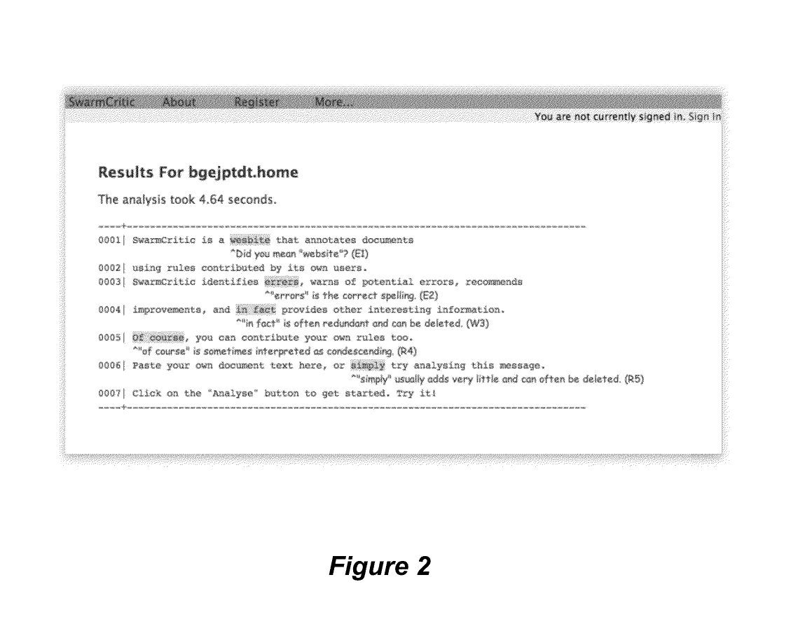

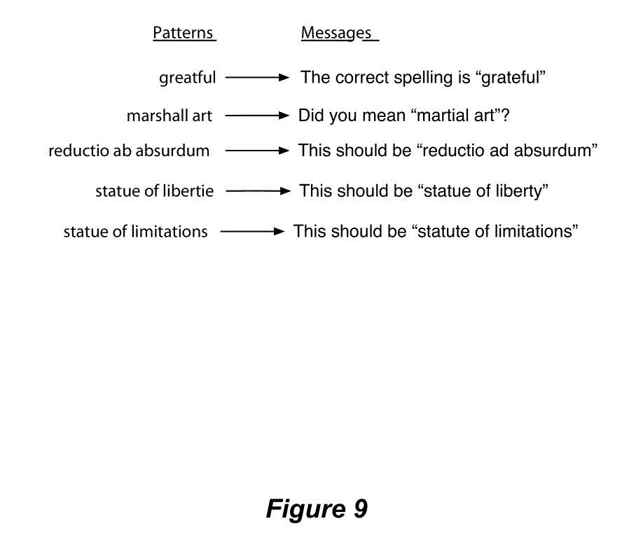

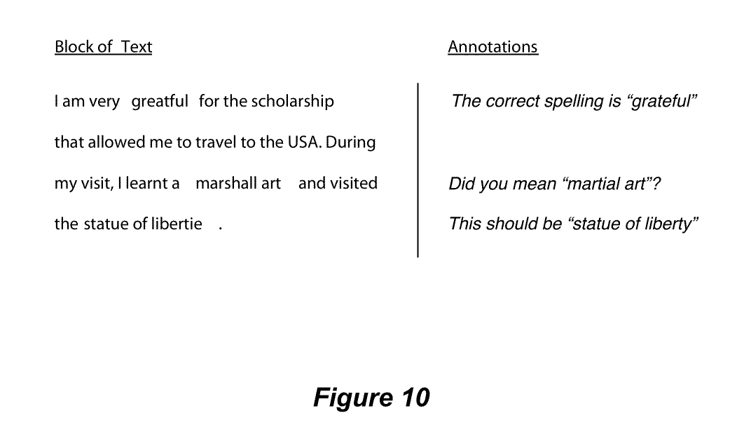

In an aspect of the invention, a ruleset of rules are defined (FIG. 9) and then applied to a block of text to yield a report (FIG. 2 and FIG. 10).

Users

It is likely that users of an aspect of the invention, particularly users who contribute rules, are likely to wish to communicate with each other about the rules stored by the system, and to be notified of changes in rules.

In an aspect of the invention, the system provides, as one example, a social networking infrastructure so that users of the system can create online identities within the system and perform social networking functions including, without limitation, storage and management of each user's name, email addresses, photo, personal web address, Facebook address, Twitter address, Skype address, YouTube address, LinkedIn address, personal summary, detailed description, city, country, friends within the system, organisation, bookmarked other users, and other users they are following. In an aspect of the invention, users can share one or more rulesets with just their social network friends, and subscribe to, and mixin, similar rulesets provided by their friends. In an aspect of the invention, program code and server/s are provided to enable users to recommend rules and rulesets to their social network friends.

In an aspect of the invention, there is a special “system” user that has special properties. For example, the system user could contain a special ruleset that all users invoke by default when they first analyse a block of text.

User Groups

In an aspect of the invention, groups of users are defined (and possibly named), each group being a subset of the set of all users. In a further aspect of the invention, groups could be defined to include or exclude the contents of other groups.

Groups can be used to define protections. For example, a rule might have a protection that specifies that the rule is visible only to those users who are members of a particular user group.

In an exemplary embodiment, a user group is defined that contains all users. For example, it might be named “public”. Similarly, a user group is defined for each user, with each user's user group containing just that user. This could be named by the user's name (e.g. “john-smith”), or as “private” (a relative name whose binding depends on the user invoking the name).

User groups could be particularly useful to define membership of an organisation. For example a group could be defined to include only those users who are employees of a particular corporation. One way to automatically implement such a group is to make membership in the group only available to users whose email address ends with the corporation's domain name. Another way is to use the user's IP address to identify the user as coming from a particular geographical location, or as coming from a particular organisation's subnet.

Rules

In an aspect of the invention, each rule embodies a single specific piece of knowledge. For example, a rule with a pattern of “incourage” and a message of “‘encourage’ is the correct spelling” embodies the specific piece of information that an occurrence of “incourage” in a block of text almost certainly represents a misspelling of the word “encourage”.

In an aspect of the invention, rules have all kinds of other attributes.

In an aspect of the invention, each rule has a unique name to which the rule can be referred. One way of doing this is to name a rule by a combination of the unique username of the user who created the rule and a rule name that is unique within that user's rules. For example, a rule could be called george-orwell̂thoughtcrime where george-orwell is the name of the creator of the rule and thoughtcrime is the rule's name (which must be unique within the rules of the user george-orwell).

In an aspect of the invention, each rule has a category which can be used in the user interface to allow the user to select rules of particular categories. Here is an example list of categories. The categories are divided into four sorted groups, which correspond roughly to the four severities: error, warning, recommendation, and information:
Factual Error—An error of fact
Grammar—A grammatical error
Misquotation—A common misquotation of another text
Misuse—A word or phrase is being misused
Obsolete—An obsolete fact, term, or phrase
Plagiarism—The text has been plagiarised
Punctuation—A punctuation error
Spelling—A spelling error
Text Virus—A text virus
Urban Legend—A false or uncertain urban legend
Illogical—A term that is illogical
Ambiguous—Ambiguous in some way
Annoying—Terms that are more annoying than offensive
Confusing—Terms that can confuse the reader
Hyperbolic—A term that is unnecessarily strong
Muddled—Terms that are often confused with other terms
Offensive—Use of a potentially offensive word
Racist—Racist language
Religious—Religious language
Scatological—Potentially offensive scatological slang
Sexist—Language that discriminates against members of one sex
Sexual—Potentially offensive sexual slang
Slang—Use of slang
Unusual Spelling—Strictly correct, but has an unusual spelling
Cliché—A cliché
Complex—A word or phrase that is unnecessarily complex
Euphemism—For terms that are overly euphemistic and can be replaced by more direct words
Jargon—Jargon for which a simpler alternative is available
Redundant—A word or phrase that contains elements that can be eliminated
Style—Something that can be improved stylistically
Weak—Weak language that lacks vigour
Advertisement—An advertisement for a product or service that relates to the text
Breaking News—Breaking news that relates to the text
Information—Provides general information relating to the text
Joke—Provides a joke that relates to the text
Reference—Provides a formal reference that relates to the text
Wikipedia—Provides a Wikipedia reference that relates to the text
Culture—Provides information about words or phrases that have specific cultural meanings
Domain—Applicable only to a specific domain of knowledge.
Other—Use this category for any rule that doesn't fit the other categories

As the categories can never be exhaustive, there can be an ability to create new categories, which can be controlled by the users, created by users, and moderated (by software or a human moderator), or unilaterally controlled by a human moderator.

In an aspect of the invention, each rule has a severity, which indicates the severity of the problem identified when a rule's pattern matches part of a block of text. In an aspect of the invention, a rule's severity takes one of the following four values:
Error—An error
Warning—Possibly an error
Recommendation—Recommendation of an alternative construct
Information—Supplementary information

In an aspect of the invention, for each rule, exactly one ruleset is identified as the rule's parent ruleset. Usually, if a ruleset is the parent of a rule, it will include the rule. In a related aspect of the invention, each rule inherits one or more attributes from its parent ruleset. For example, a rule might inherit its protection from its parent ruleset. If all the rules in a ruleset inherit their protection from their parent ruleset, setting the protection of the parent ruleset would automatically set the protection of all the rules contained by the ruleset. In a related aspect of the invention, a special “orphanage” ruleset is defined to be the parent of any rule that does not have a parent.

In an aspect of the invention, each rule has an owner, being a user. A rule's owner has special powers over the rule. In particular, the owner can define who can see and user the rule.

In an aspect of the invention, each rule has a language which indicates the language that the rule applies to. For example, the language could be English, French, or one of several computer languages such as Python or Ruby. For example, in an aspect of the invention, someone wishing to annotate a block of text in German could invoke a subset consisting only of the German rules.

In an aspect of the invention, one or more rules have a pattern in one language and a message in a different language. For example, a ruleset of rules to help Chinese people learn English could have patterns in English and messages in Chinese. The ruleset would identify common problems with English expression, but explain the problems in detail in Chinese. In a related aspect of the invention, one or more rules could have a single pattern, but a plurality of messages, each in a different language.

In an aspect of the invention, each rule has a register that is the linguistic register sought by the user in their block of text. For example, the register could be formal, informal, scientific, or colloquial.

In an aspect of the invention, tags can be associated with each rule. For example, a rule might have the tags #patent and #usa if the rule's author thought that the rule is best applied for USA (United States of America) patent documents.

In an aspect of the invention, each rule has a protection that defines who is and isn't allowed to view and invoke the rule. For example, one protection value could be private, indicating that only the user who created the rule can see and invoke it. Another value could be public, indicating that anyone is allowed to see and invoke the rule. Another value could befriends, indicating that only the rule owner user's friends in the system can see and invoke the rule. In general, a protection will specify a user group to define the set of users. In a related aspect of the invention, each rule has a separate protection for each operation that can be performed in relation to a rule including, without limitation, creating the rule, viewing the rule, modifying the rule, invoking the rule, and deleting the rule.

In an aspect of the invention, each rule has a Boolean pool attribute which indicates whether the user who created the rule wishes for the rule to be included in a special public pool of rules.

In an aspect of the invention, each rule has a date range (e.g. 8 Jan. 2011 to 12 Mar. 2011) as an additional constraint, and does not fire during dates outside that range. This feature could be used for a variety of purposes, but in particular would be useful for creating rules relating to unfolding events in the world's news cycle. Rules could be created that fire only for a limited time Similarly, rules could be created that can fire only during certain periods of the year (e.g. summer) or during certain days or months of the year, or in accordance with any other recurring temporal constraint.

In an aspect of the invention, each rule has an integer maximum matches value being the maximum number of times the rule's message can fire within a single block of text. After this number of times, remaining matches within the block of text do not fire. In a related aspect of the invention, the remaining matches are highlighted in the block of text, but are not annotated. In a related aspect of the invention, the amount of information provided in each annotation of a particular rule reduces with each match of the rule in the block of text, so that the first annotation of a particular rule provides lots of information, the next annotation of the rule less information, and so on.

In an aspect of the invention, each rule has a rating which is some function of ratings of the rule provided by users from time to time (and possibly incorporates other information such as statistics of the rule's use). For example, if the system provides “Positive” and “Negative” buttons for each rule for users to press, a rule's rating could be the total Positive button presses minus the total Negative button presses for the rule. The ratings can help to rank the matching rules when annotations must be filtered to reduce clutter. One filtering method is to use only rules whose rating exceeds a certain rating threshold set by the user. Another filtering method is to use only rules whose rating exceeds a certain rating threshold chosen automatically to achieve a certain number of annotations or density of annotations. In a related aspect of the invention, users could register as supporters of particular rules, and the more supporters a rule has, the higher its rating. In a related aspect of the invention, rules could have a rating being a number in the range [−5,5]. There are many other ways that ratings could be embodied.

In an aspect of the invention, rules have multiple versions, so that when a rule is altered, the previous version is not lost, but merely becomes inactive. In a related aspect of the invention, a user can revert a rule to an earlier version.

In an aspect of the invention, a rule can be modified and/or deleted by a user that did not create the rule. If a system of protections is being used, the protections must permit the change.

In an aspect of the invention, rules (rather than rule messages or other rule attributes) are bound to matching positions in the block of text and the user can focus on a rule that has been bound and find out more information about it, and about related rules (e.g. rules with the same pattern or rules created by the same user).

Patterns

A rule's pattern defines a set of text strings that the rule will match. Patterns can have various kinds of expressive power. This section enumerates just some of the many different kinds of patterns that could be employed in aspects of this invention.

In an aspect of the invention, one or more patterns operate in the domain of characters. For example, a pattern could be “dr.” which would match any place in the text where a “d” is followed by an “r” and then a “.”.

In an aspect of the invention, one or more patterns operate in the domain of words. For example, a pattern could be “statue of limitations” which would match any place in the text where these three words appeared in sequence, regardless of the amount of whitespace characters and punctuation appearing between them.

In an aspect of the invention, one or more patterns are required to match within a single sentence. For example, a pattern could be “statue of limitations” which would match any place in the text where these three words appeared in sequence, regardless of the amount of whitespace characters appearing between them, so long as the three words all fall within the same sentence.

In an aspect of the invention, one or more patterns are required to match within a single paragraph.

In an aspect of the invention, two or more rules have different kinds of pattern. For example, one rule could match case-sensitively and another could match case-insensitively.

In an aspect of the invention, a pattern consists of a sequence of one or more words that are matched exactly.

In an aspect of the invention, a pattern is matched case-sensitively.

In an aspect of the invention, a pattern is matched case-insensitively.

In an aspect of the invention, a pattern is matched against the block of text with all punctuation removed.

In an aspect of the invention, a pattern is matched against the block of text with all punctuation removed except for punctuation that signals the start and end of sentences.

In an aspect of the invention, a pattern is matched against the block of text with all runs of whitespace characters collapsed into a single space.

In an aspect of the invention, a rule's pattern consists of two patterns that must both match at a particular position in the block of text being analysed. Because both patterns must match, the pattern that is easier to match can be tested first and the other pattern tested only if the first matches. This aspect can be used to speed up low-speed patterns by extracting components of the low-speed pattern that can be matched at high speed. For example, consider a pattern such as “x+ long since y+” (meaning a word consisting of one or more occurrences of the letter “x” followed by the words “long” and “since” followed by a word consisting of one or more occurrences of the letter “y”. From this pattern we can derive the simpler pattern “long since” which is likely to be less computationally expensive to match (as it doesn't contain the + repetition operator), but which must match if the more complex pattern is also to match. By searching for the simpler pattern first, and only attempting to test the more complex pattern if the simple one matches, the amount of computation required to match the original pattern can be reduced.

In an aspect of the invention, a pattern is marked as an omission pattern and it fires for the block of text only if it does not match any part of the block of text. Omission patterns could be used to create rules that fire when certain parts of a block of text are missing. For example, one might add to a ruleset designed to assist in the drafting of patents, a rule that fires only if the term “Detailed Description” does not appear within the block of text. The rule's message would explain to the user that this is a required section of patents and that the missing words indicate that the section is missing. As an omission rule has no obvious position within the document to bind the message, the message could be presented at the top or bottom of the report.

In an aspect of the invention, a pattern matches any sentence whose length falls within a numerical range. For example, a rule could have a pattern that matches any sentence whose length is greater than 500 characters, and could have a message indicating that perhaps the sentence is too long and should be split. The end of the range could be specified to be a large number that is effectively infinity. Sentence length for this purpose could alternatively be measured in words.

In an aspect of the invention, a pattern matches any paragraph whose length falls within a numerical range. For example, a rule could have a pattern that matches any paragraph whose length is greater than 2000 characters, and could have a message indicating that perhaps the paragraph is too long and should be split. The end of the range could be specified to be a large number that is effectively infinity.

In an aspect of the invention, a pattern matches any document whose length falls within a numerical range.

In an aspect of the invention, a rule can have multiple patterns, and the rule matches some text if any one of its patterns matches the text.

In an aspect of the invention, a rule can have multiple patterns where a match occurs if a logical expression over the multiple patterns is true. For example, a rule could match if its first two patterns match at a particular point in the text, but its third pattern doesn't ((X and Y) and not Z).

In an aspect of the invention, a rule can have a pattern that consists simply of a block of text which must match exactly.

In an aspect of the invention, a rule can have a pattern that consists simply of a block of text and a tolerance value. The pattern matches text in the block of text if its pattern is sufficiently similar to the text. For example, at a low tolerance, only text blocks that differ only in whitespace characters would match, whereas at high tolerances whole parts of one text could be missing relative to the other text. One way to implement the matching of blocks of text with tolerance is to create an index of all n-word (e.g. n=3) sequences in the pattern block of text. Then, if any of these n-word sequences are found in the block of text being analysed, count the number of n-word sequences the two blocks have in common and declare that the two blocks match tolerantly if they have a sufficient number (or proportion) in common.

In an aspect of the invention, a rule can have a pattern that consists of a regular expression.

In an aspect of the invention, a rule can have a pattern that is expressed as a collection of grammar rules (e.g. expressed in Backus-Naur Form).

In an aspect of the invention, a pattern has a positive integer value N and does not fire for the first N occurrences of text that matches the pattern. The rule fires for each subsequent match.

In an aspect of the invention, a pattern has a positive integer value N and does not fire after the first N matches in the block of text.

In an aspect of the invention, a pattern has positive integer values M and N and fires only for the Mth to Nth matches within the block of text.

In an aspect of the invention, a pattern has a positive integer value N and does not fire unless there are at least N matches in the entire block of text being processed.

In an aspect of the invention, a pattern specifies a text pattern, a window size of W characters (or words) and a threshold D. The pattern only fires if the number of matches within a window of the block of text exceeds D.

In an aspect of the invention, each distinct pattern has its own discussion forum in which users of the system can discuss rules that have that pattern.

Messages

A rule's message is the rule's “payload”. When a rule fires, in various aspects of the invention, the message can be used to indicate why the rule has fired, why this represents a potential opportunity for the text to be improved, and how the text could be improved.

A rule's message can take many forms. A rule's message can have many components, which can be used in different situations. For example, a one-line message can be used as a reminder to users who already know about the rule, whereas an extended explanation can be provided to those who do not understand why a rule has fired.

In an aspect of the invention, each rule has one or more reference URLs, which provide additional information.

In an aspect of the invention, each rule has an example which is an example of text that contains text that matches the rule's pattern. For example, if a rule's pattern is “incourage”, the example text could be “Don't incourage him” The example text provides a concrete example of the context in which the rule's pattern might arise and could be helpful in understanding rules with obscure patterns. The example could also be used to generate example texts that fire all the rules within a ruleset.

In an aspect of the invention, each rule has a corrected example, which is the example with the identified problem corrected. For example, if a rule's example is “Don't incourage him”, the corrected example would be “Don't encourage him”

In an aspect of the invention, each rule has an icon (or an image) associated with it that can be displayed when the rule's message is invoked. For example, a rule whose pattern is “kids” and whose message is “Use the word ‘children’ unless you are referring to young goats,” could have a picture of a young goat.

In an aspect of the invention, each rule has multiple messages which can be provided to the user depending on the context. For example, if there were a short message and a long message, the short message could be displayed first, and the long one displayed only on request from the user.

In an aspect of the invention, each rule has messages in multiple languages. In a related aspect of the invention, when a rule fires, the rule's message is displayed in an appropriate language for the user.

In an aspect of the invention, each rule has a one line message that provides a summary of the problem being identified. For example, if a rule's pattern is “incourage”, the one-line message could be “The correct spelling is ‘encourage’?”

In an aspect of the invention, each rule has a one paragraph message that provides a brief description of the problem being identified.

In an aspect of the invention, each rule has an extended message that provides a detailed description of the problem being identified. The extended message could be many pages long. In an aspect of the invention, the extended message is not displayed in the annotation, but is instead referenced by the annotation (possibly using a URL).

In an aspect of the invention, each rule has one or more replacement texts. For example, if a rule's pattern were “incourage”, the replacement text would be “encourage”. A replacement text could be presented to the user as a suggestion. There could be more than one replacement text, so, in the example, an additional replacement text could be “inspire”. In an aspect of the invention, users of the system could vote on different replacement texts for a rule so that the most popular replacement text can be suggested when the rule is invoked.

In an aspect of the invention, the block of text to be analysed could be modified by the embodiment rather than merely reported upon. The modification could take the form of replacing text that matches the pattern of a rule with the rule's replacement text.

In an aspect of the invention, each rule can have one or more multimedia messages. For example, a rule might have an image and a video.

In an aspect of the invention, each rule has a sound. For example, a rule whose pattern is “PIN number” could have a sound being the sound of someone explaining why this term contains redundancy.

In an aspect of the invention, each rule has a video. For example, a rule whose pattern is “damp squid” could have video of someone explaining why this term is erroneous and could feature video of a squid and a squib.

In an aspect of the invention, each rule has its own discussion forum in which users of the system can discuss the rule. For example, if a rule's pattern is “biannual”, users could argue in the discussion forum about whether this means every six months or every two years.

The present invention is particularly useful with pattern/message rules. However, in an aspect of the invention, pattern/action rules are used instead, where an action could be any action, including, but not limited to:
Replacing the matching text with some text.
Playing a sound.
Sending an email message.
Adding an entry to a log.
Applying a simple transformation to the text such as converting it to upper case.
Linking to the rule's extended information.
Deleting the matching text.
Executing a script.

Priorities

When an analysis yields more annotations than the user wishes to see, some method of filtering the annotations must be employed before delivering a report to the user.

One way to distinguish between annotations is to assign a priority value to each rule, and use these priority values to sort the annotations. It is convenient to define the priority of entire rulesets rather than just of rules.

The priority of a rule or ruleset need not be defined for all time for all users. Instead, each ruleset can define the priority of some rules and/or rulesets, and these priorities will apply only when that ruleset is used to perform an analysis.

Priorities are useful for favouring one ruleset over another. For example, suppose that a user has created 20 rules that catch common errors that the user makes. Suppose that the user also wishes to use a general ruleset that contains 1000 rules. If the user's own ruleset is not given a higher priority, annotations generated by the general ruleset are likely to dominate any report. To solve this problem, the user could assign a priority of one to the general ruleset and two to the user's own ruleset (where two is a higher priority).

Priority values could take many forms, but typically will take the form of an integer. In an exemplary embodiment, priorities take the form of a number in the range [0,9] with 9 meaning that a rule is most important, 1 meaning that the rule is least important (except for priority 0), and 0 being a priority that prevents the rule from firing.

Rulesets

Rules can be organised into groups of rules, which will be referred to as rulesets (as each group is a subset of the set of all rules in the system). There is no requirement that each ruleset contain a unique set of rules. Two different rulesets can contain the same rules.

In an aspect of the invention, each ruleset has an owner, being a user. A ruleset's owner has special powers over the ruleset. In particular, the owner can define who can see and use the ruleset.

In an aspect of the invention, each ruleset has its own unique name. In a particular aspect of the invention, each ruleset has its own unique name consisting of the username of the user who created the ruleset followed by the ruleset's local name which is unique within the set of rulesets created by the user that created the ruleset. An example ruleset name is: “george-orwell.newspeak”.

In an aspect of the invention, each ruleset can have one or more multimedia messages. For example, a ruleset might have an image and a video.

In an aspect of the invention, where the invention is embodied as a web site, each ruleset has its own dedicated web page which contains a description of the ruleset, a link to the user who created it, and a means for applying the ruleset to a block of text.

In an aspect of the invention, for each ruleset, exactly one ruleset is identified as the ruleset's parent ruleset. If a ruleset is the parent of a ruleset, it must include the ruleset. In a related aspect of the invention, each ruleset inherits one or more attributes from its parent ruleset. For example, a ruleset might inherit its protection from its parent ruleset. In a related aspect of the invention, a special “orphanage” ruleset is defined to be the parent of any ruleset that does not have a parent. In an aspect of the invention, every ruleset is a member of a tree of rulesets whose root is the orphanage ruleset.

In an aspect of the invention, each ruleset has a protection that defines which users are allowed to view and/or invoke the ruleset. For example, one protection value could be private, indicating that only the user who created the rule can see and invoke it. Another value could be public, indicating that anyone is allowed to see and invoke the rule. Another value could be friends, indicating that only the ruleset owner user's defined friends in the system can see and invoke the ruleset. In general, a protection will specify a user group to define the set of users. In a related aspect of the invention, each ruleset has a separate protection for each operation that can be performed in relation to a ruleset including, without limitation, creating the ruleset, viewing the ruleset, modifying the ruleset, invoking the ruleset, and deleting the ruleset.

In an aspect of the invention, each ruleset has a transparency attribute which takes the value transparent or opaque. If the ruleset is transparent, then a user who can see the ruleset can also access a list of rules and rulesets in the ruleset. If the ruleset is opaque, then this information is not available to the user.

In an aspect of the invention, each ruleset has an example block of text which is a block of text that contains text that causes a selection of the rules in the ruleset to fire. The purpose of the example block of text is to act as a ready-made block of text to which users who are interested in the ruleset can apply the ruleset. In an aspect of the invention, a ruleset's example block of text is constructed from the example text of one or more of its component rules.

In an aspect of the invention, a ruleset is defined as a subset of the set of all rules.

In an aspect of the invention, each user has automatically defined rulesets that are automatically defined by the system. For example one automatically defined ruleset could be a group of all of the rules that the user has created that have a protection that makes them available to other users. Another is a ruleset that contains only rules created by the user that are not available to other users. Another is a ruleset containing all of the user's rules.

In an aspect of the invention, each user has an always-after ruleset which is invoked after whatever ruleset the user has selected to be applied to a block of text. The always-after ruleset could be used to implement a blacklist. If the always-after ruleset contained a rule at priority zero, that rule will always be at priority zero, no matter what ruleset the user chooses to apply. In a related aspect of the invention, each user has an always-before ruleset which is invoked before whatever ruleset the user has selected to be applied to a block of text. The Always-Before ruleset could be used to specify one or more rulesets at a low priority whose rules are to be invoked if the ruleset the user has selected does not result in firings for particular parts of the block of text.

In an aspect of the invention, the user has a home ruleset which is the ruleset that is applied if the user does not specify a ruleset when analysing a block of text.

In an aspect of the invention, the user has an automatically-defined pool ruleset which is a ruleset that contains all the rules that the user has created that the user has submitted to a global pool of rules contributed by many users.

In an aspect of the invention, each ruleset has a rating which is some function of ratings of the rule provided by users from time to time (but which could also incorporate other information such as rule popularity). For example, if the system provides “Positive” and “Negative” buttons for each ruleset for users to press, a ruleset's rating could be the total Positive button presses minus the total Negative button presses for the rule. This rating could be used to order rulesets when the user has searched for rulesets by keyword. A ruleset's rating could also be defined to depend on the ratings of its rules.

In an aspect of the invention, each ruleset has its own label for the button that users use to request an analysis using that ruleset. For example, one ruleset might have a button label of “Analyse Document”. Another ruleset might have a button label of “Analyse Philosophy Essay”. Another ruleset might have a button label of “Unleash the Critics”.

In an aspect of the invention, each ruleset has an icon (or an image) associated with it that can be displayed in association with the ruleset.

In an aspect of the invention, each ruleset has a sound. For example, a ruleset about a political system could have the sound of a famous political speech.

In an aspect of the invention, each ruleset has a video. For example, a ruleset about patents could have video of someone explaining about how to write a patent.

In an aspect of the invention, each ruleset has its own discussion forum in which users of the system can discuss the ruleset. For example, users might wish to debate whether the ruleset should or should not contain a particular kind of rule.

In an aspect of the invention, ruleset have multiple versions, so that when a ruleset is altered, the previous version is not lost, but merely becomes inactive. In a related aspect of the invention, a user can revert a ruleset to an earlier version.

In an aspect of the invention, each ruleset has a graphical theme which is displayed in association with the ruleset. For example, a ruleset about dolphins might have a graphical theme of dolphins at play. In an aspect of the invention, a ruleset's icon and theme mean that a ruleset's web page becomes instantly identifiable, reducing the chance of the user invoking the wrong ruleset by mistake.

In an aspect of the invention, one or more tags can be associated with a ruleset. For example, a ruleset might have the tags #patent and #usa if the ruleset's author thought that the rule is best applied for USA patent documents. In an aspect of the invention, a ruleset's set of tags could be automatically defined to be the union of the sets of tags associated with the rules in the ruleset.

In an aspect of the invention, each user can define a set of rulesets that the user finds particularly interesting (a “bookmark list”).

In an aspect of the invention, a facility is provided that makes it easy for a user to “subscribe” to a particular ruleset, for example, by pressing a subscription button on the ruleset's web page. When a user subscribes to a ruleset, an entry is added to one of the user's ruleset's definition lists containing a reference to the subscribed-to ruleset (and possibly a priority). In particular, subscriptions could be added to the user's Home ruleset by default.

In an aspect of the invention, the aspect presents to the user a list of the most popular rules and rulesets.

In an aspect of the invention, some rulesets are created automatically by software that accesses information on the internet. For example, a ruleset containing false urban legends could be created automatically by creating software that “crawls” the major urban legend websites, and creates a rule for each false urban legend with the rule's pattern being the block of text that is circulated when the false urban legend is propagated, and the rule's message being a brief note that this is a false urban legend with a web hyperlink to the false urban legend's webpage in an urban legend website. Similarly, a ruleset of common spelling errors could be created automatically by creating software to crawl the major dictionary websites that list common misspellings, and create rules whose pattern is a common misspelling and whose message is a note that it is a misspelling with a link to the dictionary website. Similarly, a ruleset of misquotations could be created automatically. Similarly, a ruleset of clichés could be created automatically Similarly, a ruleset of trademarks could be created automatically from a trademarks database Similarly a ruleset of offensive language could be created automatically.

Ruleset Inclusions

In their simplest definitional form, rulesets are directly defined to contain a specified subset of rules. However, there are several other ways in which the contents of rulesets could be defined.

In an aspect of the invention, a ruleset X that is the parent of a rule Y includes the rule.

In an aspect of the invention, a ruleset X that is the parent of a ruleset Y includes the entire contents of Y, taking into account Y's inclusions.

In an aspect of the invention, in addition to other mechanisms, a ruleset can include one or more other rulesets. These are called “mixins”. For example, a ruleset X created by user U could be defined to be all the rules in rulesets Y and Z, and to also include rules R1 and R2. In an aspect of the invention, Y and Z might not be created by U, but by a different user. As rulesets can include other rulesets, there could be several levels of reference involved.

Mixins provide a lot of flexibility. For example, if one user created a ruleset X containing rules that identify spelling errors, and another user created a ruleset Y containing rules that identify grammatical errors, it might be advantageous for a third user to be able to create a ruleset Z that contains the contents of these two rulesets, with Z including X and Y by reference rather than by actually copying their contents. By referring to X and Y rather than copying their contents, the ruleset Z wouldn't need to be updated whenever X and Y change.

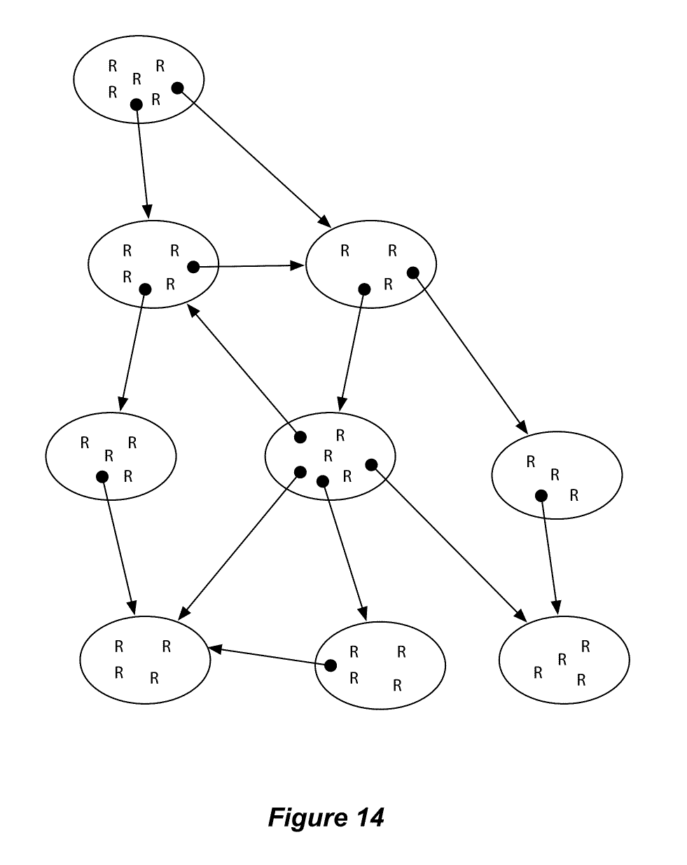

In practice, ruleset inclusions will form complex directed graph structures (FIG. 14). A single ruleset might be configured to directly and indirectly include the rules of hundreds of other rulesets.

In an aspect of the invention, where the inclusion graph of rulesets contains a cycle, the cycle is adequately catered for, and does not cause infinite loops or any similar problems. For example, if ruleset X includes ruleset Y, and ruleset Y includes ruleset Z, and ruleset Z includes ruleset X, there would be a cycle of length three, and the implementation must detect the cycle, and handle it sensibly. Cycles can be detected when exploring a graph structure by maintaining a stack of nodes visited, and stopping further exploration in a particular direction when the node about to be visited is already in the stack.

In an aspect of the invention, a ruleset X is defined by a list, each entry in the list consisting of either a rule or a ruleset. Ruleset X is defined to be the union of all the rules in the list and all the rules in the rulesets in the list.

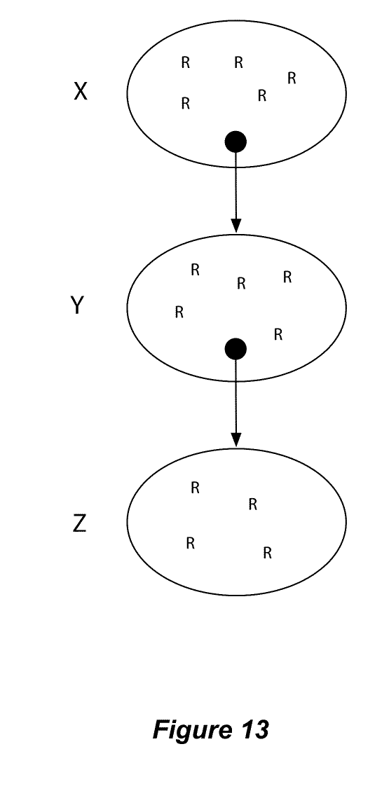

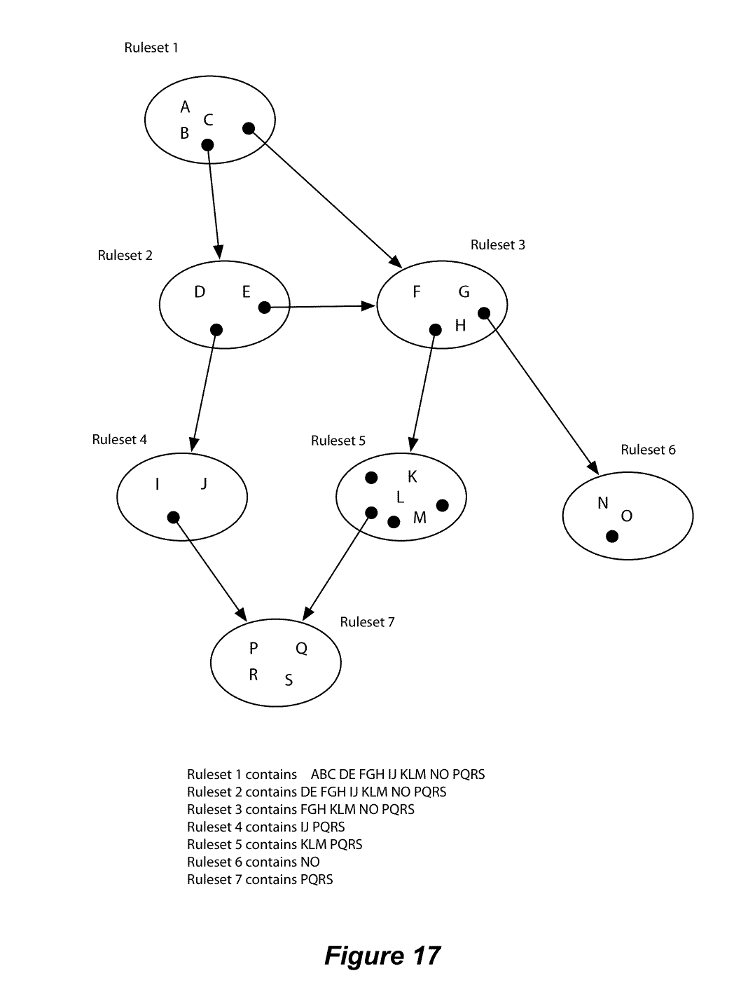

In an aspect of the invention, each ruleset can include other rulesets, and those rulesets can contain other rulesets, so that the rulesets are connected together in a complicated structure (FIG. 13). The rules in a ruleset are then the union of the transitive closure of the rulesets that it includes (FIG. 17).

In a more complicated aspect of the invention, rulesets can both include and exclude the rules in another ruleset. For example, a ruleset X might specify that it includes the rules in ruleset Y, but excludes the rules in ruleset Z. So X would end up containing all the rules that are in Y, but not Z. In this aspect of the invention, we soon run into questions of precedence. For example, if a ruleset includes rulesets A and B, but excludes C and D, do we regard the exclusions as overriding all of the inclusions? Adding the rules in A, subtracting the rules in C, adding the rules in B, and then subtracting the rules in D will yield a different ruleset from adding A and B and then subtracting C and D.

One way to resolve the precedence issue is to organise a ruleset's inclusions and exclusions as a list of commands to be executed (to be called an “inclusion list”). For example:
+A
−C
+B
−D

This list says to add the rules in A, then exclude the rules in C, then add the rules in B, and then exclude the rules in D.

A ruleset defined using lists can be represented as a boolean array that indicates whether each rule in the universe of rules is in the ruleset.

Inclusions and Priorities

Priority values can be incorporated into ruleset lists by attaching a priority to each entry in the list. The priority values replace the − and + indicators shown earlier, with 0 corresponding to − and values in the range [1,9] corresponding to +(and refining it). For example:
5 A
0 C
3 B
0 D

Rankings can be calculated if a ruleset assigns a priority value (e.g. in the range [0,9]) to each rule rather than a boolean that simply defining whether the rule is included. To implement rule priorities, the boolean array is replaced with an array of priority values (e.g.) in the range [0,9]. Whereas previously each ruleset defined a subset of rules, under the enriched structure, a ruleset assigns a priority value (e.g. in the range [0,9]) to each rule in the system, with 0 meaning that the rule is not a member of the ruleset and [1,9] meaning that the rule is a member with the specified priority.

Whereas − and + values define set inclusion and exclusion and are straightforward, numerical priority values present a number of choices. Given that a ruleset now defines a priority vector that might contain different priorities for different rules, how is a command such as “3 B” above to be interpreted? Here are some possibilities:
Masking: The members of B that have a non-zero priority are assigned a priority of 3.
Copying: The members of B that have a non-zero priority within B retain that priority (with the 3 being ignored).
Scaling: The members of B that have a non-zero priority are assigned a priority being their existing priority multiplied by 3/9.
Normalised Scaling: The members of B that have a non-zero priority are scaled so that the highest priority in the scaled B is 9. Then these values are multiplied by 3/9.

Ultimately, each ruleset defines a priority vector, which constitutes the ruleset's entire semantics.

In some aspects of the invention, it will be advantageous for priority vectors to include empty values in addition to priority values. If a rule's priority in a priority vector is “empty”, it means that the vector ignores the rule. When this vector is blended with another vector that does specify a priority for the rule, the second vector will take precedence.

Ratings

If an embodiment of the invention has many users and rules, it is likely that there will be many rules that share the same pattern. It is also likely that some rules will be inappropriate, erroneous, or will contain spam messages. For all these reasons, it's important that the system be able to gather rating information from its users and create a rating for each rule and ruleset.

In an aspect of the invention, users provide ratings (or information that can be used to calculate ratings) of rules, messages, rulesets, and users. In a further aspect of the invention, the user can only provide one rating for any one rule, message, ruleset, or user. If the user provides a second rating for a given rule, message, ruleset or user, the first rating is ignored. In a related aspect of the invention, ratings are an integer in a negative to positive range (e.g. −5 to 5).

In an aspect of the invention, each object can be rated using a negative and positive scale (e.g. −5 . . . 5).

In an aspect of the invention, a user can blacklist a rule, ruleset, or a user, causing those rules, rulesets, and users to be omitted from any block of text analysis for the particular user. In a related aspect of the invention, if a particular rule, ruleset, or user appears in a significant number of users' blacklists then the rule, ruleset, or user becomes blacklisted for all users.

In an aspect of the invention, a user can praise a rule, ruleset, or user, causing those rules, rulesets, and users that are praised to be more likely to fire during an analysis.

In an aspect of the invention, rules have parameters and user ratings are automatically used to tune the parameters. For example, in the case where a rule has a pattern that consists of a paragraph that is matched tolerantly according to a tolerance parameter, the system could automatically experiment with different tolerance parameters and use the value that leads to the highest user ratings. Setting the tolerance too high would result in false positive annotations that users would rate poorly. Setting the parameter too low would result in the false negatives, reducing the rule's utility. Setting the parameter to the optimal value would result in many useful firings with a tolerable rate of false positives (if any).

Wiki

In an aspect of the invention, a wiki space for rules and rulesets is created in which any user can create, read, modify, and delete rules and ruleset. The wiki space might be implemented simply by creating a new user in the system (e.g. called “wiki”) who grants permission for other users to modify objects owned by the user.

In an aspect of the invention, users cannot modify wiki rules and rulesets directly, but instead must propose changes (including creation and deletion) to a rule or ruleset, and these changes are then placed in a queue for evaluation by other users. If sufficient other users approve of the change, the change is implemented. This kind of process could be necessary to reduce spam.

Statistics

In an aspect of the invention in which a plurality of users enter rules and invoke each other's rulesets and rules, users will be interested in whether the rules they provide for use by other users are being used. In an aspect of the invention, various events are logged and analysed, and statistics and graphs generated for the benefit of users. For example, the system could create a record each time a rule matches, and each time a rule fires. The system could log the use of each ruleset, in particular distinguishing between the use of a ruleset by a user and the use of a ruleset by another ruleset.

Reports

The results of an analysis can be employed in a variety of ways, but will usually be displayed to a user in some form.

In an aspect of the invention, a block of text is analysed by applying a ruleset of rules. In one aspect of the invention, a message is associated with the block of text for every match of every rule in the ruleset.

However, if there are millions of rules contributed by millions of users, there are likely to be many rules with the same pattern, and many rules with patterns that occur frequently in blocks of text. It is likely that it will become a practical necessity for there to be a limit on the absolute number or density of rule firings. For example, a user might request that only three messages be displayed, or that there be at most three firings per paragraph. Even though some aspects of the invention might be capable of providing thousands of annotations to the user in less than one second, the user's lack of time to correct the block of text will place a limit on the usefulness of large numbers of firings. For these reasons, exemplary embodiments of the invention will need to rank the rule firings, and present only the most useful messages.

In an aspect of the invention, only the message of the most useful rule firing is displayed (by some metric of “useful”).

In an aspect of the invention, only the messages of the best N matching rules are displayed (by some metric of “best”).

One way of determining the best rules is to rank them by some numerical metric. A metric can be created by blending some combination of a rule's priority (as assigned by its invoking ruleset), rating, and severity. In particular, it might be advantageous for priority to dominate severity, and for severity to dominate rating. For example, if a rule's severity is represented as a number in the range [1,4] (e.g. error=4, warning=3, recommendation=2, information=1), and the rule's rating is represented as a number in the range [−5,5] and the priority is a number in the range [0,9], then the metric could be calculated using the formula: metric=(100×priority)+(10×severity)+rating.

In addition to selecting the most useful messages to display, aspects of the invention could provide the information in various forms.

In an aspect of the invention, the analysis report provides messages which are hyperlinked to additional information about the message or its associated rule.

In an aspect of the invention, users submit a block of text in a popular document format (such as Microsoft Word or PDF) and the embodiment of the invention annotates it and returns a modified copy of the document with the annotations added as comments. In a related aspect of the invention, particular rules that have recommended replacement text are replaced automatically in the document.

In an aspect of the invention, following an analysis of a block of text, the user marks one or more rule firings and these firings do not occur the next time the same (or similar) block of text is analysed. This aspect can be used to allow the user to mark rule firings that the user has read, but has decided not to action, so that they do not appear again when the next version of the block of text is analysed.

In an aspect of the invention, following an analysis of a block of text, the user receives only summary statistics of the analysis. For example, the user could be presented only with the number of rules of error severity that fired. This could be used as a metric of the quality of the text. A number of other similar metrics could be employed.

Interface

Aspects of the invention could present the invention to users using a variety of interfaces. In particular, a web interface is an exemplary embodiment of the invention.

In an aspect of the invention, the invention is presented using a web interface and a page in the web provides a web form with a text field into which users can paste text to be analysed. When the form is submitted, the text is analysed and the results displayed. In a further aspect of the invention, pasting a URL into the text field results in the referenced web page's content being retrieved and analysed instead of the URL.

In an aspect of the invention, each rule and ruleset has its own web page.

In an aspect of the invention, the invention provides users with achievement badges for various milestones in the user's interaction with the embodiment. For example, there could be badges for:
First analysis of a block of text;
First ten analyses of ten blocks of text;
First creation of a rule;
First creation of a ruleset;
First ten rules created; and
First rule contributed to the public pool.

In an aspect of the invention, there is a distinguished ruleset called (for example) the global ruleset, which contains all rulesets that users create with a particular special name (for example the name “global”). This ruleset could be configured to be the default ruleset that is included in user's home rulesets. In a further aspect of the invention, the global ruleset is assigned a low priority so that if the user adds other rulesets to their home ruleset, the rules in those added rulesets take priority over those in the global ruleset.

In an aspect of the invention, users subscribe to rulesets. These rulesets are added to the user's home ruleset so that when the user performs an analysis, all the subscribed-to rulesets are applied to the block of text.

In an aspect of the invention, each user provides information about themselves (e.g. their political leanings) that is then used to calculate a similarity distance metric between each pair of users. The priority of rules and rulesets is then adjusted for each user based on information on the users most similar to the user. For example, a user could assign a higher priority to rules created by users whose political leanings are similar to the user.

In an aspect of the invention, each user has an expertise level (being for example a number from 1 to 5). The interface only reveals functionality appropriate for the user's current expertise level. To increase their level, the user must read some information on the functionality that appears in the next level and confirm that they want to upgrade to the next level.

In an aspect of the invention, the site requests the user for their username and password, after they have registered. If the user cannot provide these, the user is sent back to the registration form. This is preferable to the user not being able to log in following registration (e.g. because the user has forgotten their password) and then never being able to access their account again.

In an aspect of the invention, statistics are kept on users, rules, and rulesets, and a list of the most popular users, rulesets, and rules is provided to users, thereby allowing users to browse the most popular rules and rulesets.

In an aspect of the invention, many rules can have the same pattern. When the rules are all applied together, the results are sorted by priority, rating, severity, and other metrics so that only the messages that are likely to be most useful to the user are displayed.

In an aspect of the invention, two or more rules can share the same message.

In an aspect of the invention, the user can rapidly create a ruleset by entering just the essential fields of several pattern/message pairs (e.g. into a single web form), where each pattern consists of a simple pattern (e.g. a list of words) and the message consists of a short message (e.g. a one line message). In this interface, all of the other attributes of the rules are set to default values.

In an aspect of the invention, rules and rulesets are exported and imported using CSV, XML or other data formats.

In an aspect of the invention, an embodiment of the invention is presented to the internet using a network API (Application Programming Interface), allowing other software and websites to send a block of text to be analysed, and receive analysis results. For example, blogging software could employ this API by providing a button within the blog software that invokes a particular ruleset and displays the results. This would allow users who are about to post to a blog to analyse their text first. The API could provide other functionality too, such as allowing a rule to be updated.

In an aspect of the invention, an embodiment of the invention is presented to the internet using an email interface. A user sends a document (or block of text) by email to an email interface (which has an email address), and the interface analyses the text and sends back an email containing an analysis report. The user could specify the ruleset to be invoked in the email In a related aspect of the invention, the user emails a word processing document file (e.g. a Microsoft Word file) and the interface performs an analysis of the document and sends back an email containing an attachment with the same document but with annotations inserted, forming the analysis report. In a further related aspect of the invention, the user submits the document by web form and receives an annotated version of the document by email. In a further related aspect of the invention, the user provides the document by email and then accesses the analysis report on a website.

In an aspect of the invention, an embodiment of the invention is integrated into the user's word processing software (e.g. Microsoft Word) so that the user can invoke the analysis function directly for the document (perhaps with a single keystroke). In a related aspect of the invention, the analysis report is presented to the user in the form of inserted mark-up, comments, and annotations within the document.

In an aspect of the invention, other text analysis systems are incorporated into an embodiment of the invention to be applied in parallel with one or more rulesets. For example, separate grammar checker software could be integrated with an embodiment of the invention so that messages relating to grammatical errors appear in the text alongside messages caused by firing rules. In this way, an embodiment of the invention could provide a central analysis interface for a variety of other text analysis tools. In an aspect of the invention, these other analysis systems are incorporated within the ruleset model and presented within the system as rulesets that can be mixed with other rulesets.

In an aspect of the invention, the analysis report is presented to the user using an interactive interface that allows the user to filter the annotations using various controls. For example, the interface could provide controls for the number of annotations to be displayed, the seventies of annotation to be displayed (e.g. error, warning, recommendation, informational), the maximum density of annotations to be displayed, the categories of annotations to be displayed, and the kinds of message to be displayed (e.g. long, short).

Implementation

The simplest way to perform matching is to run through the block of text once for each rule searching for matches to the rule's pattern. If there are R rules and the block of text is T characters long, then applying the R rules to the text will require approximately R×T matching operations (O(RT) operations in complexity notation). (Note: Each matching operation might require several character comparisons).

This is practical for small sets of rules. However, for large sets of rules, the number of operations required will make the system too slow. For example, if the text is 10,000 characters long, and there are one million rules, then matching them using this simple method will require about ten billion operations. Modern CPUs can perform approximately two billion operations per second, so the matching operation would take of the order of five seconds of CPU time. This is impractical for (e.g.) a web server that must process many text analysis requests per second.

How can thousands, or even millions, of rules to be applied to a single document at high speed, so that the report is generated in (say) less than one second? There are a variety of possible implementations.

A Word Tree Implementation

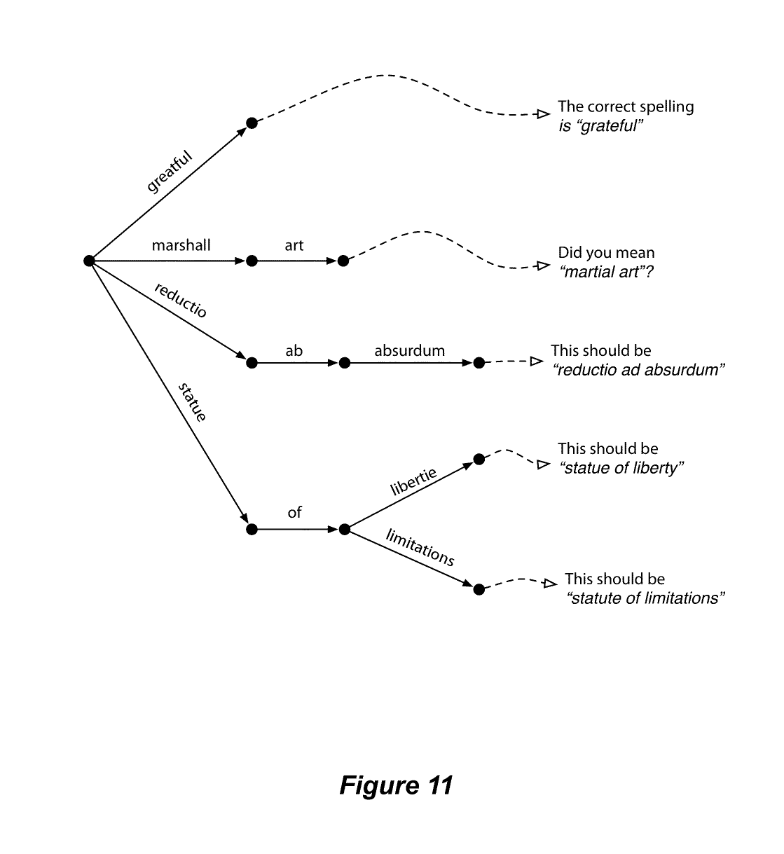

To speed up the matching, the rules can be represented in a data structure that enables all the rules' patterns to be matched against the block of text in a single pass (i.e. in O(T) time). There are many ways to do this, but one simple method is to organise the patterns into a word tree, where each arc in the tree is labelled with a word, and each node in the tree represents a string, and each other node's string is the concatenation (with a space) of the words on the arcs leading from the root to the node (with the root node representing the empty string). Each node in the tree points to one or more corresponding rules (or rule messages). FIG. 11 shows a word tree corresponding to the rules of FIG. 9. To match the tree with the text, start just before the first word in the text and use the words that follow in the text to traverse the tree. Display the messages for each node in the tree that is traversed (except the root node). Then move past the first word in the text and repeat the process. The tree data structure means that the matching process will require O(T) operations because (assuming that matches are rare) during each step, the tree traversal process usually won't move past the root. Even if it does move past the root, it will probably only go a few levels (note that the average pattern length above is small), which is effectively an O(1) operation. Overall, the time complexity (of the non-matching scanning) is O(T) and this is R times faster than the O(RT) complexity for the simple implementation. If R is one million, it will be one million times faster.

As it is necessary to traverse the word tree for each word in the text, it's important that the word tree be stored in a high-speed storage medium such as random access memory (RAM) rather than slower storage medium such as hard disk.

In an aspect of the invention, the word tree is constructed from the rules in reverse with the first level being the last word in each pattern. The text is scanned in reverse from its end to its beginning.

Other Implementations

There are a variety of other ways of representing the rules that enables them to be applied to a text in a single pass.

Instead of organising the tree by words, it can be organised by characters so that each arc in the tree is labelled with a single character. This produces a much deeper tree, but with a much smaller average furcation.

In another method, instead of using a tree, each pattern (consisting of a sequence of words) is hashed and inserted into a hash table (with a link to the corresponding rule). At each position (word) in the text, the next word is hashed and looked up in the table. Then the next two words are hashed and looked up in the table. Then the next three words are hashed and looked up in the table. This continues for up to M words, where M is the maximum number of words in a pattern. The algorithm then moves to the next position (start of word) in the text and repeats. This method could also be applied at a character level.

In another method, patterns are required to be at least N characters long. One n-character substring is selected from each pattern as a representative of the pattern, and these are stored in a hash table that links to the corresponding rules. To match with a text, an N-character window is slid through the text one character at a time and the contents of the window hashed at each position and looked up in the table. The rules that are found there are then matched more completely against the surrounding text.

In summary, there are many ways of representing a collection of rule patterns in a way that allows them to be matched against a text in a single pass of the text. These representations, whatever their form, will be referred to as “condensations” and the process of creating these representations will be referred to as “condensing”.

Implementations Employing Concurrency

There are a number of ways in which concurrency (performing more than one operation at the same time) can be employed in embodiments of the invention.

When matching patterns against a block of text, the matching task could be distributed between a number of processing units.

When matching patterns against a block of text and generating annotations, the two processes could be performed in parallel so that annotations are generated soon after a match is detected rather than after all matching has completed.

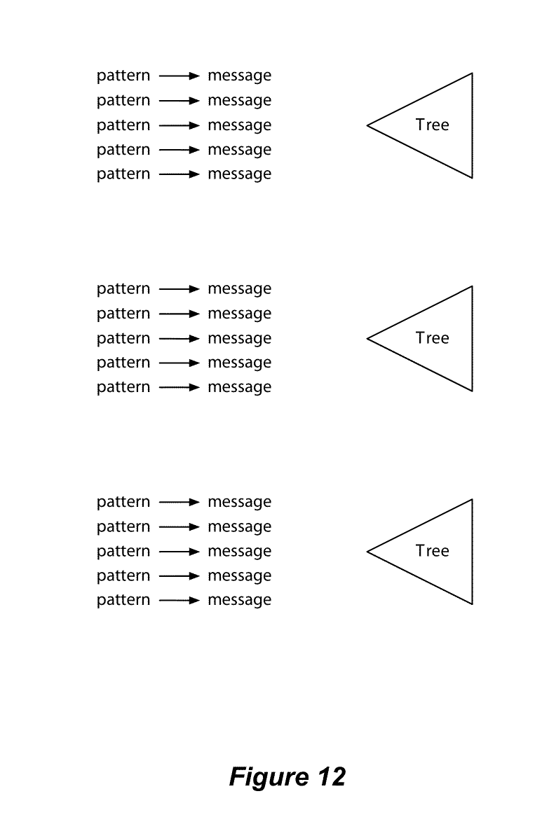

Many RulesetsCondensations can be constructed for many different rulesets. Consider the situation where there are S rulesets, each consisting of an average of R rules. A user may wish to analyse a block of text with any one of the rulesets. This can be achieved by condensing each ruleset. FIG. 12 shows three rulesets, each of which contains five rules. A condensation (in this example, a tree) has been constructed for each ruleset. When the user provides a block of text and selects a ruleset, the selected ruleset's condensation can be applied to the text immediately and at high speed.

Consider the situation where there are S rulesets, each consisting of an average of R rules. Suppose there are rulesets X, Y, and Z, each with 10,000 rules, where ruleset Y includes ruleset X, and ruleset Z includes ruleset Y. Invoking ruleset X will invoke just the rules in X, but invoking ruleset Y will invoke the rules in both X and Y. Invoking ruleset Z will invoke the rules in X, Y, and Z. FIG. 13 shows this example with a smaller number of rules in each ruleset.

One way to apply rulesets that include other rulesets is to use the inclusion graph to compute the set of rules corresponding to each ruleset and to construct a condensation for each ruleset. This will work, but because of the connections between rulesets, there is likely to be significant duplication. In the example, if rulesets X, Y, and Z each contain 10,000 rules (directly), and each included each other, there would be three condensations, each of which would contain the patterns for the same 30,000 rules. As a result, codensations for 90,000 rules would have to be stored instead of condensations for 30,000 rules, a 66% memory inefficiency.

To save memory, a condensation can be constructed for each ruleset, with each condensation containing only the patterns corresponding to the rules (directly) contained within each ruleset. When the user presents a text for analysis by ruleset X, the condensation for X can be applied, then the condensation for Y (because X includes Y), and then the condensation for Z, in sequence with the results being combined to generate the text analysis.

Creators of embodiments can choose different trade-offs between memory consumption and speed. For more speed but more memory consumption, create a condensation of the entire contents each ruleset. For less memory consumption, but less speed, create a condensation of only the direct contents of each ruleset.

Applications

This invention has a wide range of applications. Some of them are described below.

General Document Preparation:

Embodiments of the invention could be used to perform general checks on documents.

General Email Communications:

Embodiments of the invention could be used to check email messages before they are sent, particularly if the invention were integrated into email client software.

A general purpose ruleset could be employed. Among other benefits, the use of the invention before sending an email could reduce the propagation of false urban legends and other false rumours.

University Essay Marking:

University professors who set and mark essays could create a plurality of rules and publish them as a ruleset for their students to apply to their essays before submitting the essays. There could be a general ruleset of rules shared by all professors, a university-wide subset, a departmental ruleset, and an essay-question-specific ruleset. Each ruleset could include the ruleset at the next broader level (e.g. the departmental ruleset could include the university-wide ruleset).

Corporate Communications:

Companies often wish to influence the language with which the outside world (and in particular business journalists) discusses the company. Companies also wish to correct misconceptions about their markets, history, and products. So a company could create a ruleset and publish it for use by those writing about the company. For example, a company that is repositioning its product from “small truck” to “large car” could add a rule that matches “small truck” and provides a message that says that the company now views its products as “large cars”. Similarly, if there is a false rumour about the company, the company could add a rule whose pattern is keywords appearing in the rumour and which provides a message that explains that the rumour is false and refers to references. Another corporate application is in detecting errors in documents leaving the company. A company could create a ruleset for use by anyone in the company who creates documents. For example, if a company phone number has changed, a rule could be added whose pattern matches the old phone number and whose message says that that number is the old number and to use the new number instead. A company could also use a ruleset internally to assist staff to avoid offensive language, or to use imprecise language. There are many other uses for this invention in corporations.

Law Firms:

There are many applications for this invention within law firms. For example, when a new significant legal precedent appears that renders an old one obsolete, a rule could be added to the firm's ruleset whose pattern matches the citation of the old case and whose message refers the user to the new precedent. A firm could create a ruleset for particular kinds of legal documents with rules with omission patterns to ensure that certain constructs are not omitted from certain kinds of legal documents. A firm could create a ruleset to recognise clauses that are obsolete or defective.

Software Engineers:

Software engineers can use this invention to detect errors in their software. For example, a rule could be added whose pattern is a function call whose return value is not subsequently checked. A rule could be added to warn programmers of the use of any library function that programmers commonly make errors calling Similarly all kinds of other rules could be added to detect dangerous constructs in software.

Book Editing:

Particular styles of writing use particular sets of words instead of other sets of words. Embodiments of the invention could be used by book editors (and their authors) to identify words and phrases for which there is a more appropriate alternative, given the desired style. For example, a ruleset for authors of books for young readers could have a rule for each commonly-used long word that suggests a shorter alternative.

Revenue Models

If the invention is embodied as a website on the internet with many users, it will require revenue to pay for the array of servers serving the website. Embodiments of the invention could be deployed using a variety of revenue models.

In an aspect of the invention, users are charged a one time fee.

In an aspect of the invention, users are charged a regular fee. For example, users could be charged a monthly, quarterly, or annual fee.

In an aspect of the invention, users are charged per N blocks of text they analyse.

In an aspect of the invention, users are charged only if they wish to create opaque rulesets.

In an aspect of the invention, users can use the system for free, but are charged a fee if they wish to create a rule or ruleset not visible to other users. This model is based on the idea that those who are not contributing to the user community should pay.

In an aspect of the invention, individuals can use an embodiment of the invention for free, but corporations must purchase a licence of some kind for their users.

In an aspect of the invention, use of an embodiment of the invention is free for a defined time period, after which the user must pay a fee.

In an aspect of the invention, users of an embodiment can use the embodiment free for N reports, where N is a positive integer, after which they must pay a fee. In a related aspect of the invention, users can perform up to N analyses each time period (e.g. month), after which they must pay until the start of the next time period.

In an aspect of the invention, users can use an embodiment of the invention for free, but can pay a fee to increase the speed of the website.

In an aspect of the invention, users can use an embodiment of the invention for free, but must purchase a subscription to access additional functionality,

In an aspect of the invention, users can use an embodiment of the invention for free, but engineers who wish to use the embodiment's application programming interface (API) must pay a fee of some kind to do so.

In an aspect of the invention, an embodiment of the invention is packaged into a physical appliance that is sold to the user.

In an aspect of the invention, a mechanism is provided so that users can themselves charge for the use of their rulesets (under some model), with a percentage of the fee going to the host of the invention.

In an aspect of the invention, advertisements are presented with the analysis results. In particular, keywords appearing in the block of text to be analysed can be used to determine the advertisements to be displayed. For example, if the block of text being analysed refers to gardens, the site could display advertisements for garden tools. Advertisers could bid for particular keywords.

In an aspect of the invention, instead of displaying advertisements directly, there is instead a discreet advertisement line at the top of the report saying that the user can click to view advertisements on a specific topic. For example at the top of the page, there could be text saying “View advertisements about solar panels”, with the keyword text in bold being hyperlinked to a page of advertisements.

In an aspect of the invention, the analysis report contains a section (e.g. a column) that links to Google searches (or some other search engine) for various high-value keywords that appear in the document. This section could simply be a column on the right hand side of the analysis results page that links to Google for various high-value keywords that appear in the document. For example:
Google solar panels

with the keyword text in bold hyperlinked to a page of advertisements. This could alternatively be placed at the top of the results page.

When sourcing and displaying advertisements, there is a need to be careful with privacy as the simplest way to determine the best advertisements would be to send the block of text to be analysed to a search engine company and let it determine the best advertisements to run. However, this would disclose the user's text to the search engine company. Similarly, if the site extracted low-frequency words and sent them to the search engine site for advertising analysis, this might be a breach of privacy too, as, for example, a low-frequency word might actually be a password. A technique that could be used to display relevant advertisements while preserving user privacy is to receive a list of keyword/advertisement pairs from the search engine in advance, match them against incoming blocks of text, and then display them as appropriate. Even in this case, care would have to be taken not to create advertisement access correlations that provide too much information about the blocks of text being analysed. In an aspect of the invention and advertisement could be a message associated with the block of text and the result of the firing of a rule.

No Restriction

It will be appreciated by those skilled in the art that the invention is not restricted in its use to the particular application described. Neither is the present invention restricted in its preferred embodiment with regard to the particular elements and/or features described or depicted herein. It will be appreciated that various modifications can be made without departing from the principles of the invention. Therefore, the invention should be understood to include all such modifications within its scope.

Details concerning computers, computer networking, software programming, telecommunications, and the like may, at times, not be specifically illustrated as such were not considered necessary to obtain a complete understanding nor to limit a person skilled in the art in performing the invention, are considered present nevertheless as such are considered to be within the skills of persons of ordinary skill in the art.

A detailed description of one or more preferred embodiments of the invention is provided along with accompanying figures that illustrate by way of example the principles of the invention. While the invention is described in connection with such embodiments, it should be understood that the invention is not limited to any embodiment. On the contrary, the scope of the invention is limited only by the appended claims and the invention encompasses numerous alternatives, modifications, and equivalents. For the purpose of example, numerous specific details are set forth in the following description in order to provide a thorough understanding of the present invention. The present invention may be practiced according to the claims without some or all of these specific details. For the purpose of clarity, technical material that is known in the technical fields related to the invention has not been described in detail so that the present invention is not unnecessarily obscured.

“Logic,” as used here in, includes but is not limited to hardware, firmware, software, and/or combinations of each to perform a function(s) or an action(s), and/or to cause a function or action from another component. For example, based on a desired application or needs, logic may include a software controlled microprocessor, discrete logic such as an application specific integrated circuit (ASIC), or other programs are logic device. Logic may also be fully embodied as software.

“Software,” as used here in, includes but is not limited to one or more computer readable and/or executable instructions that cause a computer or other electronic device to perform functions, actions, and/or behave in a desired manner. The instructions may be embodied in various forms such as routines, algorithms, modules or programs including separate applications or code from dynamically linked libraries. Software may also be implemented in various forms such as a stand-alone program, a function call, a servlet, an applet, instructions stored in a memory, part of an operating system or other type of executable instructions. It will be appreciated by one of ordinary skill in the art that the form of software is dependent on, for example, requirements of a desired application, the environment it runs on, and/or the desires of a designer/programmer or the like.

Those of skill in the art would understand that information and signals may be represented using any of a variety of technologies and techniques. For example, data, instructions, commands, information, signals, bits, symbols, and chips may be referenced throughout the above description may be represented by voltages, currents, electromagnetic waves, magnetic fields or particles, optical fields or particles, or any combination thereof.

Those of skill in the art would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The steps of a method or algorithm described in connection with the embodiments disclosed herein may be embodied directly in hardware, in a software module executed by a processor, or in a combination of the two. For a hardware implementation, processing may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. Software modules, also known as computer programs, computer codes, or instructions, may contain a number a number of source code or object code segments or instructions, and may reside in any computer readable medium such as a RAM memory, flash memory, ROM memory, EPROM memory, registers, hard disk, a removable disk, a CD-ROM, a DVD-ROM or any other form of computer readable medium. In the alternative, the computer readable medium may be integral to the processor. The processor and the computer readable medium may reside in an ASIC or related device. The software codes may be stored in a memory unit and executed by a processor. The memory unit may be implemented within the processor or external to the processor, in which case it can be communicatively coupled to the processor via various means as is known in the art.

Throughout this specification and the claims that follow unless the context requires otherwise, the words ‘comprise’ and ‘include’ and variations such as ‘comprising’ and ‘including’ will be understood to imply the inclusion of a stated integer or group of integers but not the exclusion of any other integer or group of integers.

The reference to any background or prior art in this specification is not, and should not be taken as, an acknowledgment or any form of suggestion that such background or prior art forms part of the common general knowledge.

1. A method for annotating a block of text using a plurality of rules, comprising:
storing a plurality of rules created by a plurality of entities, each rule comprising a text pattern and at least one message;
defining a plurality of rulesets;
identifying a particular ruleset;
matching the text patterns of the rules in the particular ruleset to the block of text;
associating with the block of text the message of at least one rule having a matching pattern; and
annotating the block of text with the associated message or messages.

2. A method of claim 1, wherein the at least one message is associated with a part of the block.

3. The method of claim 1, wherein the at least one rule has a plurality of patterns and fires if any of its patterns matches.

4. The method of claim 1, wherein the at least one rule has a plurality of patterns and fires if all of its patterns match.

5. The method of claim 1, wherein the at least one rule has a plurality of patterns and is applicable if the matching status of the patterns satisfies a logical expression.

6. The method of claim 1, wherein the at least one rule associates a messages only if the rule's pattern does not match any part of the block of text.

7. The method of claim 1, wherein the pattern of the at least one rule comprises a block of text and matches similar blocks of text with some tolerance for differences.

8. The method of claim 1, wherein the at least one pattern comprises a sequence of one or more words.

9. The method of claim 1, wherein the at least one pattern comprises a regular expression.

10. The method of claim 1, wherein the at least one rule is applicable only if the rule includes a pattern that matches at least K parts of the block of text, where K is a parameter of the rule or embodiment.

11. The method of claim 10, wherein the at least one rule not associate its message if the pattern associated with the at least one rule is a pattern that has already matched at least K previous parts of the block of text.

12. The method of claim 1, wherein the at least one rule comprises a plurality of messages.

13. The method of claim 1, wherein the message of the at least one rule comprises information in one or more of the following forms: text, image, audio, video, discussion forum, web URLs, replacement text, example text.

14. A method for replacing at least one part of a block of text using a plurality of rules comprising:
storing a plurality of rules created by a plurality of entities, each rule comprising a text pattern and at least one message;
defining a plurality of rulesets;
identifying a particular ruleset;
matching the text patterns of the rules in the particular ruleset to the block of text; and
replacing at least one part of the block of text with the rule's replacement text.

15. (canceled)

16. The method of claim 15, wherein the at least one ruleset includes another ruleset.

17. The method of claim 16, wherein the including ruleset assigns a priority to the included ruleset.

18. The method of claim 16 further comprising:
defining at least one ruleset by a list of entries, each entry identifying a rule or a ruleset.

19. The method of claim 18 further comprising:
defining at least one ruleset by a list of entries, each entry naming a rule or a ruleset and specifying a priority.

20. The method of claim 16 further comprising:
associating information to at least one ruleset, the information including one or more of text, image, audio, video, discussion forum, web URLs, and example text.

21. The method of claim 1 further comprising:
ranking rules by a metric calculated from one or more aspects of the rules.

22. The method of claim 21, wherein the rule rankings are used to filter the annotations.

23. The method of claim 22, wherein the highest-rated N rule instances become annotations, where N is a positive integer.

24. The method of claim 1, wherein at least one predetermined firing is eliminated following a previous matching step of the same, or similar, block of text or part of a block of text.

25. The method of claim 1 further comprising:
producing a document embodying the block of text having annotations.

26. A system for annotating a block of text comprising:
a memory for storing a plurality of rules created by a plurality of entities, a plurality of rules comprising a text pattern and a message and storing the block of text; and
a processor configured to receive the block of text, define a plurality of rulesets, identify a particular ruleset, match the text patterns the rules in the particular ruleset to the stored block of text associate with the block of text the message of at least one rule having a matching pattern, and annotate the block of text with the associated message or messages.

27. A system for annotating a block of text comprising:
a memory for storing a plurality of rules created by a plurality of entities, a plurality of rules comprising a text pattern and a message and storing the block of text; and
a processor configured to receive the block of text, define a plurality of rulesets, match the text patterns of the rules in a particular ruleset to the stored block of text, and associate with the block of text the message of at least one rule having a matching pattern; and
an information presentation arrangement configured to present information comprising at least one rule's message with at least one part of the stored block of text.

28. A system for annotating a block of text comprising:
a plurality of memories for storing a plurality of rules created by a plurality of entities, a plurality of rules comprising a text pattern and a message and storing the block of text some of which are physically remote from each other and some of which contain one or more of a plurality of rules, and blocks of text in, with memories in communication with another memory and in communication with one or more of the plurality of processors; and
a plurality of processors some of which are physically remote from each other in communication with another processor, the processors configured to receive the block of text, define a plurality of rulesets, identify a particular ruleset, match the text patterns of the rules in the particular ruleset to the stored block of text and associate with the block of text the message of at least one rule having a matching pattern and the message or messages annotating the block of text.

29. A method of for annotating a block of text using a plurality of rules comprising:
storing a plurality of rules created by a plurality of entities, each rule comprising a text pattern and a message;
defining a plurality of rulesets;
identifying a particular ruleset;
matching the text patterns of the rules in the particular ruleset to the block of text;
associating with the block of text at least one rule having a matching pattern; and
annotating the block of text with the message of the associated rule or rules.

30. A method for managing a plurality of rules for the purpose of annotating a block of text comprising:
providing a plurality of entities a means for submitting rules, each rule comprising a text pattern and a message,
storing submitted rules;
defining a plurality of rulesets for the purpose of annotating a block of text;
storing a plurality of rules created by a plurality of entities;
defining a plurality of rulesets;
identifying a particular ruleset;
matching the text patterns of a plurality of the rules in the particular ruleset to the block of text;
associating with the block of text the message of at least one rule having a matching pattern; and
annotating the block of text with the associated message or messages.

31. The method of claim 30 further comprising:
enabling the modification of at least one rule by an entity that did not create the rule.

32. The method of claim 30 further comprising:
enabling entities to rate of one or more rules.

33. A computer program product, comprising a computer usable medium having a computer readable program code embodied therein, said computer readable program code adapted to be executed to implement a method for annotating a block of text using a plurality of rules created by a plurality of entities, a plurality of rules comprising a text pattern and a message, the method comprising the steps of:
matching the text patterns of a plurality of rules to the block of text;
associating with the block of text the message of at least one rule having a matching pattern; and
annotating the block of text with the associated message or messages.

34. A computer program product, comprising a computer usable medium having a computer readable program code embodied therein, said computer readable program code adapted to be executed to implement a method for managing a plurality of rules for the purpose of annotating a block of text, comprising the steps of:
providing a plurality of entities a means for submitting rules, each rule comprising a text pattern and a message,
storing submitted rules; and
providing a plurality of rules for the purpose of annotating a block of text by:
matching the text patterns of a plurality of rules to the block of text; and
associating with the block of text the message of at least one rule having a matching pattern; and
annotating the block of text with the associated message or messages.
